(19) United States
(12) Patent Application Publication
(10) Pub. No.: US 2026/0362370 A1
(43) Pub. Date: Nov. 12, 2026

(54) ASSOCIATION BETWEEN AREA ID AND POSITIONING METHODS FOR AI/ML-BASED POSITIONING

(71) Applicant: QUALCOMM Incorporated, San Diego, CA (US)

(72) Inventors: Alexandros MANOLAKOS, Athens (GR); Mukesh KUMAR, Hyderabad (IN); Srinivas YERRAMALLI, San Diego, CA (US)

(21) Appl. No.: 19/113,835

(22) PCT Filed: Nov. 14, 2023
(86) PCT No.: PCT/US2023/037241

§ 371 Date: Mar. 20, 2025

(30) Foreign Application Priority Data
Dec. 6, 2022 (GR) 20220101010

(51) Int. Cl. H04W 64/00; H04B 17/318; H04W 4/021; H04W 8/22; H04W 24/02

(52) U.S. Cl. CPC H04W 64/00; H04B 17/328; H04W 4/021; H04W 8/22; H04W 24/02

(57) ABSTRACT

Aspects presented herein relate to methods and devices for wireless communication including an apparatus, e.g., a UE or a network entity. The apparatus may obtain a request to perform a set of positioning methods for at least one area ID in a set of area IDs associated with one or more areas, where each of the set of positioning methods corresponds to one or more area IDs. The apparatus may also perform at least one positioning method of the set of positioning methods based on the UE being within one area of the one or more areas associated with the set of area IDs. The apparatus may also transmit a report of the at least one positioning method based on the UE being within the one area of the one or more areas.

### CROSS-REFERENCE TO RELATED APPLICATION

This application claims the benefit of Greece Patent Application Serial No. 20220101010, entitled “ASSOCIATION BETWEEN AREA ID AND POSITIONING METHODS FOR AI/ML-BASED POSITIONING” and filed on Dec. 6, 2022, which is expressly incorporated by reference herein in its entirety.

### TECHNICAL FIELD

The present disclosure relates generally to communication systems, and more particularly, to positioning measurements in wireless communication systems.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be an apparatus for wireless communication at a user equipment (UE) (e.g., a wireless device). The apparatus may transmit, for a network entity, an indication of a UE capability for an association of a set of area IDs to a set of positioning methods, where a positioning method configuration is based on the indication of the UE capability. The apparatus may also transmit an indication of a list of suitable or favored positioning methods, where a positioning method configuration is based on the list of suitable or favored positioning methods. The apparatus may also obtain a request to perform a set of positioning methods for at least one area identifier (ID) in a set of area IDs associated with one or more areas, where the request includes a positioning method configuration for the set of area IDs associated with the one or more areas, where each of the set of positioning methods corresponds to one or more area IDs in the set of area IDs, where the positioning method configuration includes information associated with a performance of the set of positioning methods. Additionally, the apparatus may perform at least one positioning method of the set of positioning methods based on the UE being within one area of the one or more areas associated with the set of area IDs. The apparatus may also transmit, for a network entity after the performance of the at least one positioning method, a report of the at least one positioning method based on the UE being within the one area of the one or more areas. The apparatus may also perform at least one second positioning method of the set of positioning methods based on the UE being within a second area of the one or more areas associated with the set of area IDs, where the at least one positioning method is different from the at least one second positioning method and a first area ID for the one area is different from a second area ID for the second area. Further, the apparatus may transmit a second report of the at least one second positioning method based on the UE being within the second area of the one or more areas.

In an aspect of the disclosure, a method, a computer-readable medium, and an apparatus are provided. The apparatus may be an apparatus for wireless communication at a network entity (e.g., a server or a location management function (LMF)). The apparatus may receive, from a user equipment (UE), an indication of a UE capability for an association of a set of area IDs to a set of positioning methods, where a positioning method configuration is configured based on the indication of the UE capability. The apparatus may also receive an indication of a list of suitable or favored positioning methods, where a positioning method configuration is configured based on the list of suitable or favored positioning methods. The apparatus may also configure a positioning method configuration including a set of positioning methods for a set of area IDs associated with one or more areas, where each of the set of positioning methods corresponds to one or more area IDs in the set of area IDs, where the positioning method configuration includes information associated with a performance of the set of positioning methods. Also, the apparatus may transmit, for a user equipment (UE), a request to perform the set of positioning methods for at least one area ID in the set of area IDs associated with the one or more areas, where the request includes the positioning method configuration for the set of area IDs associated with the one or more areas. The apparatus may also receive a report of at least one positioning method of the set of positioning methods based on the UE being within one area of the one or more areas. The apparatus may also receive a second report of at least one second positioning method of the set of positioning methods based on the UE being within a second area of the one or more areas, where the at least one positioning method is different from the at least one second positioning method and a first area ID for the one area is different from a second area ID for the second area.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of a wireless communication system.

FIG. 6 is a diagram illustrating an example positioning procedure.

FIG. 7 is a diagram illustrating example regions for positioning measurements.

FIG. 8 is a diagram illustrating an example communication flow for an artificial intelligence (AI)/machine learning (ML) training procedure.

FIG. 9 is a diagram illustrating example regions for positioning methods.

FIG. 10 is a diagram illustrating example regions for positioning methods.

FIG. 11 is a diagram illustrating example report configurations for positioning sessions.

FIG. 12 is a diagram illustrating example positioning models for different UE capabilities.

FIG. 13 is a communication flow diagram illustrating example communications between a UE and a network entity.

FIG. 14 is a flowchart of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a diagram illustrating an example of a hardware implementation for an example apparatus and/or network entity.

FIG. 19 is a diagram illustrating an example of a hardware implementation for an example network entity.

FIG. 20 is a diagram illustrating an example of a hardware implementation for an example network entity.

### DETAILED DESCRIPTION

Different aspects of positioning may also utilize preconfigured downlink (DL) positioning reference signal (PRS) assistance data (AD). Preconfigured DL PRS AD may refer to the DL-PRS assistance data (with associated validity criteria) that may be provided to the UE (e.g., before or during an ongoing LTE positioning protocol (LPP) positioning session), to be then utilized for potential positioning measurements at a subsequent time (e.g., for deferred mobile terminated location request (MT-LR)). In some aspects, pre-configured DL-PRS assistance data may include multiple instances, where each instance may be applicable to a different area within the network. Also, each DL-PRS assistance data instance may be associated with an area identifier (ID). In some instances, the area ID may include a list of cells where the UE may be camped on/connected. Further, an applicable area ID at the UE location may be selected based on the cell where the UE is camped on/connected. The instance of the assistance data may be valid/selected if the UE is camped on/connected to one of the cells indicated within the list of cells in the area ID. In some aspects, there may be model performance variation for positioning methods or measurements. For instance, a neural network (NN)-based artificial intelligences (AI) or machine learning (ML) model may not be reliable. As ML may be considered a data-driven solution, the quality of the data may determine the performance of the downlink (DL) application. However, the realistic deployment environments may be more complicated than expected, and the performance of the deployed model may be worse. For example, in the model preparation stage (e.g., training/validation/testing), the prepared dataset may not cover all of the potential scenarios. So, model performance in the inference may largely vary in diverse environments. In order to ensure the performance, the system may monitor the model status, and be configured to optimize the model when the performance is worse. For example, in the model status monitoring, ML model outage detection may ensure a basic communication link. Also, a ML output may be verified (e.g., by value or traditional model/algorithm). If the output is likely wrong, the inference host may use a traditional model/algorithm instead. Further, some aspects of AI/ML model monitoring may include at least one of: periodical model status reporting, a UE triggering the model status reporting, a network triggering the UE report, model fallback, or network actions for the model update. Additionally, in some aspects, there may be model switching for AI/ML models. As ML utilizes data-driven solutions, different ML models may be designed to adapt diverse conditions and tasks. For the flexible model management, the models may be grouped into different sets including different grouping rules. For example, the models may be grouped into different sets based on the model complexity. Also, the models may be grouped into different sets based on the model functions or tasks. For some groups, a network may need to trigger the group switching to adapt different conditions. In some instances, there may be many grouping rules, and the grouping may be based on one rule or the combination of some rules. In one case, one group may be mapped to a single ML model, where the group switching is equal to a single model configuration. If the conventional algorithms are grouped, the model group switching may also include the configuration between conventional algorithms and ML models. Some types of positioning may utilize direct AI/ML positioning. For instance, direct AI/ML positioning may include details of the channel observation used as the input of the AI/ML model inference (e.g., type and size of model input), model input acquisition, and pre-processing. Other types of positioning may utilize AI/ML assisted positioning. For instance, AI/ML assisted positioning may include details of the channel observation used as the input of the AI/ML model inference (e.g., type and size of model input), model input acquisition, and pre-processing. Also, AI/ML assisted positioning may include details of the output of the AI/ML model inference, or how the AI/ML model output is used to obtain the UE's location. In some aspects, different regions/sites may perform differently for given positioning methods. Indeed, there may be a tradeoff between power and positioning accuracy. For example, carrier phase measurements may perform better in line of sight, indoor scenarios and/or have huge performance loss. Also, the performance of TOA may be better compared to AOD and cooperative positioning (CP) in non-line-of-sight (NLOS). Based on training available to ML models, ML may outperform and/or underperform compared to legacy-based 5G positioning methods. Also, dilution of precision (DOP) may be different for different methods. Aspects of the present disclosure may provide information regarding which positioning method will perform better for a given location. For instance, aspects presented herein may provide information regarding which positioning method will perform better for a given location in order to select a suitable positioning method. For example, aspects presented herein may provide a wireless device (e.g., a UE or location management function (LMF)) information regarding which positioning method will perform better for a given location in order to select a suitable positioning method. By doing so, the wireless device (e.g., a UE or LMF) may select a suitable or ideal positioning method for a corresponding cell/area or area ID. In some instances, aspects presented herein may provide a request to perform a set of positioning methods for a set of area IDs associated with one or more cells/areas. Also, the set of positioning methods may correspond to one or more area IDs in the set of area IDs. Further, the wireless device (e.g., a UE or LMF) may perform at least one of the set of positioning methods based on the UE being within a certain cell area. Accordingly, a suitable or ideal positioning method may be performed for a corresponding cell/area or area ID. Thus, the wireless device (e.g., a UE or LMF) may save on power and/or performance during the positioning process.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

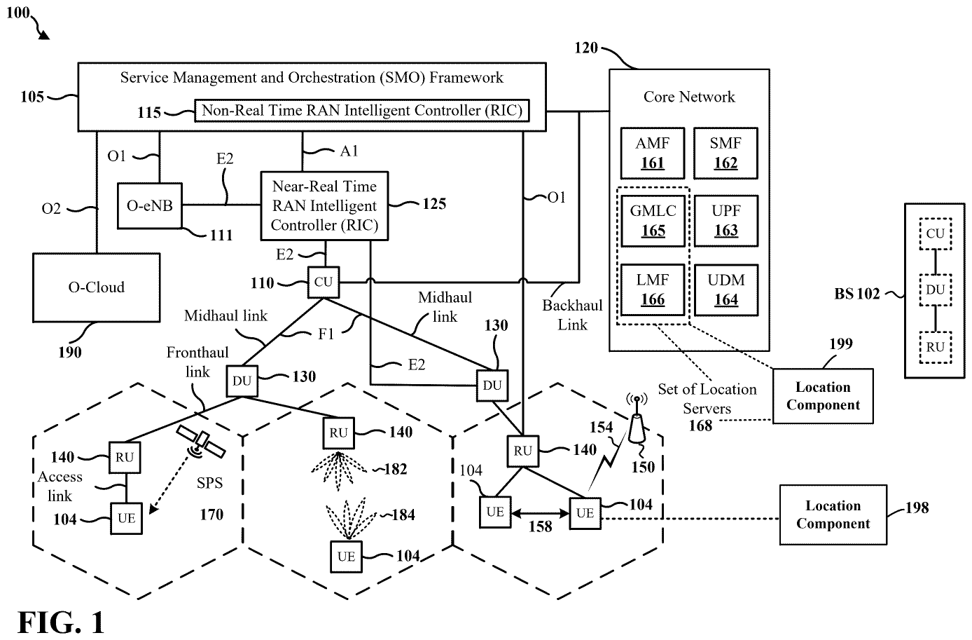

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and a velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network. In some scenarios, the term UE may also apply to one or more companion devices such as in a device constellation arrangement. One or more of these devices may collectively access the network and/or individually access the network. A network node can be implemented as a base station (i.e., an aggregated base station), as a disaggregated base station, an integrated access and backhaul (IAB) node, a relay node, a sidelink node, etc. A network entity can be implemented as a base station (i.e., an aggregated base station), or alternatively, as a central unit (CU), a distributed unit (DU), a radio unit (RU), a Near-Real Time (Near-RT) RAN Intelligent Controller (RIC), or a Non-Real Time (Non-RT) RIC in a disaggregated base station architecture.

Referring again to FIG. 1, in certain aspects, the UE 104 may include a location component 198 that may be configured to transmit, for a network entity, an indication of a UE capability for an association of a set of area IDs to a set of positioning methods, where a positioning method configuration is based on the indication of the UE capability. Location component 198 may also be configured to transmit an indication of a list of suitable or favored positioning methods, where a positioning method configuration is based on the list of suitable or favored positioning methods. Location component 198 may also be configured to obtain a request to perform a set of positioning methods for at least one area identifier (ID) in a set of area IDs associated with one or more areas, where the request includes a positioning method configuration for the set of area IDs associated with the one or more areas, where each of the set of positioning methods corresponds to one or more area IDs in the set of area IDs, where the positioning method configuration includes information associated with a performance of the set of positioning methods. Location component 198 may also be configured to perform at least one positioning method of the set of positioning methods based on the UE being within one area of the one or more areas associated with the set of area IDs. Location component 198 may also be configured to transmit, for a network entity after the performance of the at least one positioning method, a report of the at least one positioning method based on the UE being within the one area of the one or more areas. Location component 198 may also be configured to perform at least one second positioning method of the set of positioning methods based on the UE being within a second area of the one or more areas associated with the set of area IDs, where the at least one positioning method is different from the at least one second positioning method and a first area ID for the one area is different from a second area ID for the second area. Location component 198 may also be configured to transmit a second report of the at least one second positioning method based on the UE being within the second area of the one or more areas.

In certain aspects, the LMF 166 and/or the set of locations servers 168 may include a location component 199 that may be configured to receive, from a user equipment (UE), an indication of a UE capability for an association of a set of area IDs to a set of positioning methods, where a positioning method configuration is configured based on the indication of the UE capability. Location component 199 may also be configured to receive an indication of a list of suitable or favored positioning methods, where a positioning method configuration is configured based on the list of suitable or favored positioning methods. Location component 199 may also be configured to configure a positioning method configuration including a set of positioning methods for a set of area IDs associated with one or more areas, where each of the set of positioning methods corresponds to one or more area IDs in the set of area IDs, where the positioning method configuration includes information associated with a performance of the set of positioning methods. Location component 199 may also be configured to transmit, for a user equipment (UE), a request to perform the set of positioning methods for at least one area ID in the set of area IDs associated with the one or more areas, where the request includes the positioning method configuration for the set of area IDs associated with the one or more areas. Location component 199 may also be configured to receive a report of at least one positioning method of the set of positioning methods based on the UE being within one area of the one or more areas. Location component 199 may also be configured to receive a second report of at least one second positioning method of the set of positioning methods based on the UE being within a second area of the one or more areas, where the at least one positioning method is different from the at least one second positioning method and a first area ID for the one area is different from a second area ID for the second area. Although the following description may be focused on 5G NR, the concepts described herein may be applicable to other similar areas, such as LTE, LTE-A, CDMA, GSM, and other wireless technologies.

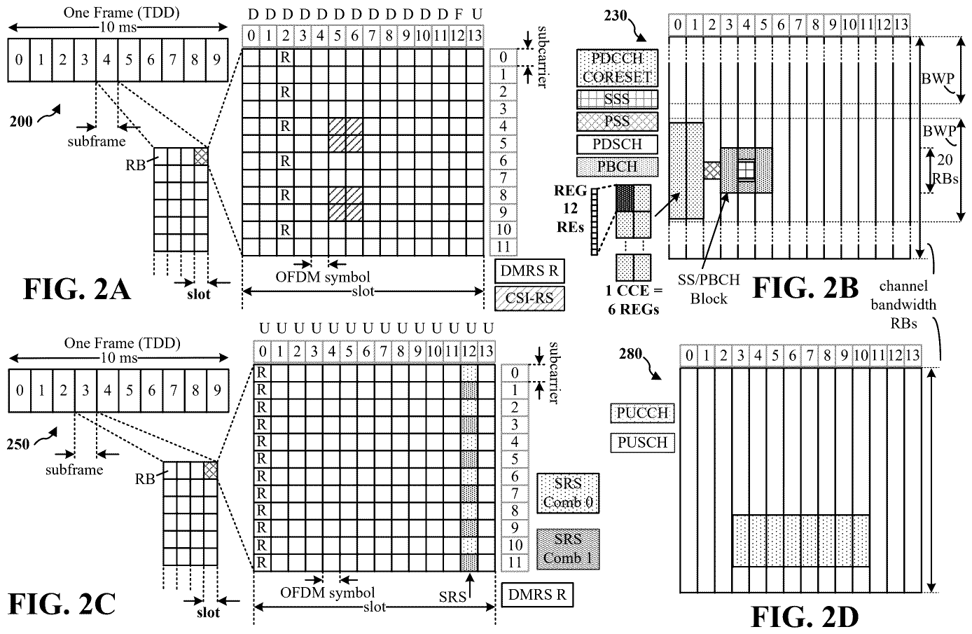

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

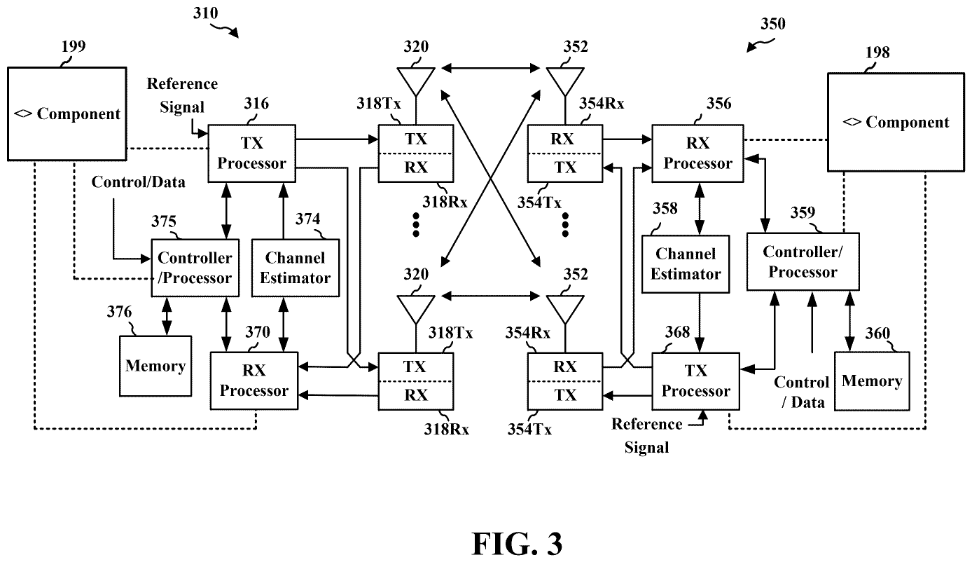

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the location component 198 of FIG. 1. At least one of the TX processor 316, the RX processor 370, and the controller/processor 375 may be configured to perform aspects in connection with the location component 199 of FIG. 1.

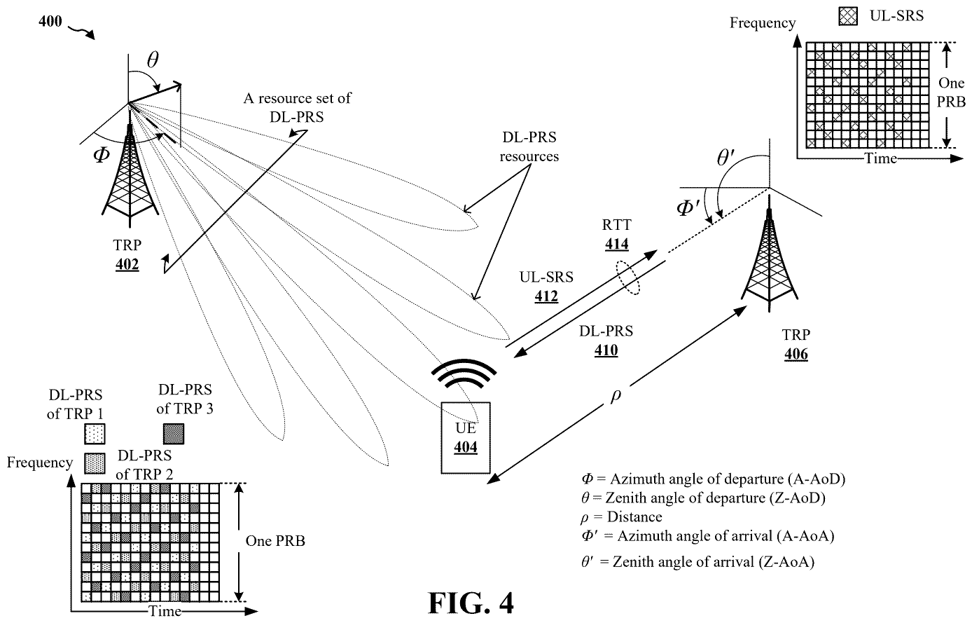

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and DL-PRS-RSRP of the received signals) using assistance data received from the positioning server, and the TRPs 402, 406 measure the gNB Rx-Tx time difference measurements (and UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406. DL-TDOA positioning may make use of the DL reference signal time difference (RSTD) (and DL-PRS-RSRP) of downlink signals received from multiple TRPs 402, 406 at the UE 404. The UE 404 measures the DL RSTD (and DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and UL-SRS-RSRP) at multiple TRPs 402, 406 of uplink signals transmitted from UE 404. The TRPs 402, 406 measure the UL-RTOA (and UL-SRS-RSRP) of the received signals using assistance data received from the positioning server, and the resulting measurements are used along with other configuration information to estimate the location of the UE 404. UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

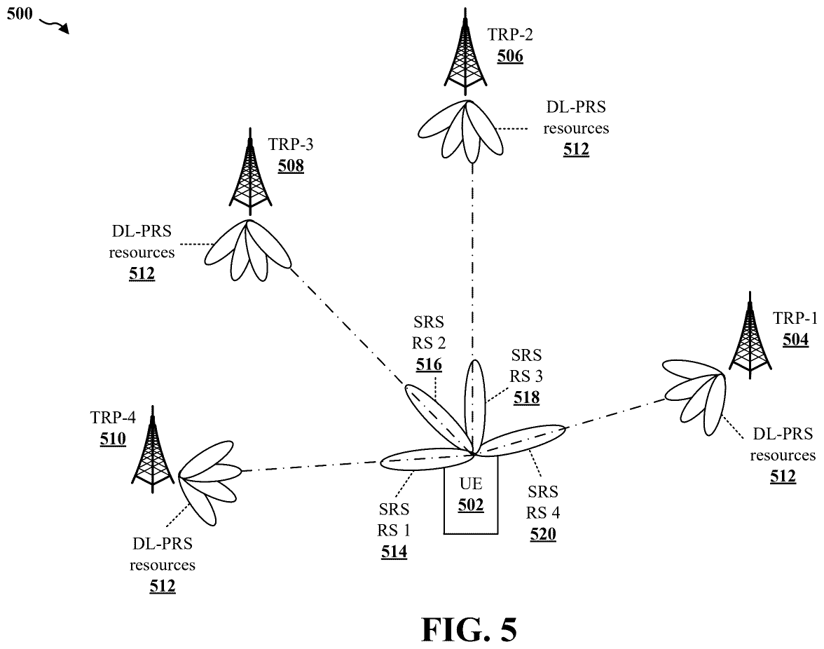

FIG. 5 is a diagram 500 illustrating an example of estimating a position of a UE based on multi-RTT measurements from multiple TRPs in accordance with various aspects of the present disclosure. A UE 502 may be configured by a serving base station to decode DL-PRS resources 512 that correspond to and are transmitted from a first TRP 504 (TRP-1), a second TRP 506 (TRP-2), a third TRP 508 (TRP-3), and a fourth TRP 510 (TRP-4). The UE 502 may also be configured to transmit UL-SRSs on a set of UL-SRS resources, which may include a first SRS resource 514, a second SRS resource 516, a third SRS resource 518, and a fourth SRS resource 520, such that the serving cell(s), e.g., the first TRP 504, the second TRP 506, the third TRP 508, and the fourth TRP 510, and as well as other neighbor cell(s), may be able to measure the set of the UL-SRS resources transmitted from the UE 502. For multi-RTT measurements based on DL-PRS and UL-SRS, as there may be an association between a measurement of a UE for the DL-PRS and a measurement of a TRP for the UL-SRS, the smaller the gap is between the DL-PRS measurement of the UE and the UL-SRS transmission of the UE, the better the accuracy may be for estimating the position of the UE and/or the distance of the UE with respect to each TRP.

In some aspects of wireless communication, the terms “positioning reference signal” and “PRS” may generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. In some aspects, a downlink positioning reference signal may be referred to as a “DL-PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

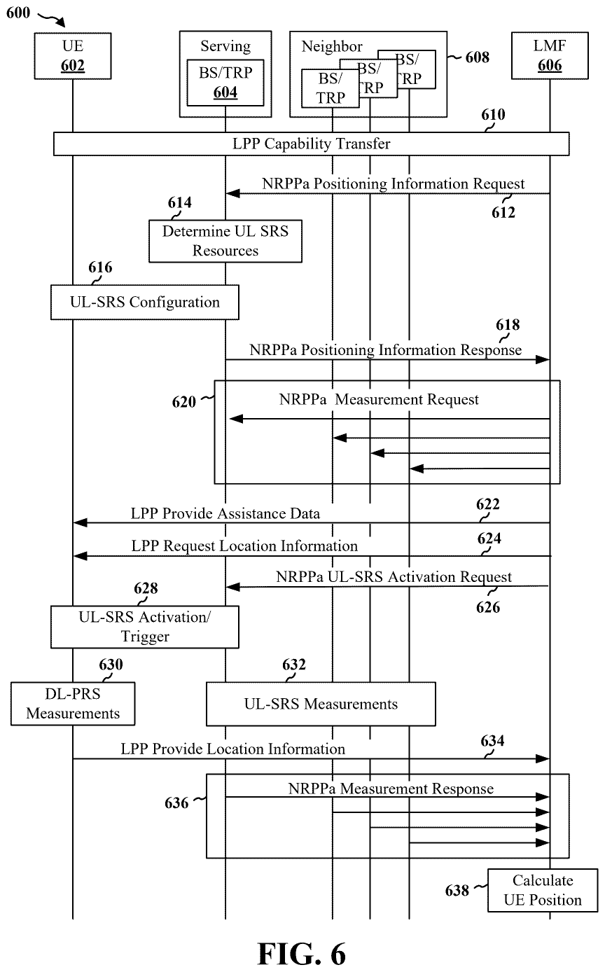

FIG. 6 is a communication flow 600 illustrating an example multi-RTT positioning procedure in accordance with various aspects of the present disclosure. The numberings associated with the communication flow 600 do not specify a particular temporal order and are merely used as references for the communication flow 600. In addition, a DL-only and/or an UL-only positioning may use a subset or subsets of this multi-RTT positioning procedure.

At 610, an LMF 606 may request one or more positioning capabilities from a UE 602 (e.g., from a target device). In some examples, the request for the one or more positioning capabilities from the UE 602 may be associated with an LTE Positioning Protocol (LPP). For example, the LMF 606 may request the positioning capabilities of the UE 602 using an LPP capability transfer procedure. At 612, the LMF 606 may request UL SRS configuration information for the UE 602. The LMF 606 may also provide assistance data specified by a serving base station 604 (e.g., pathloss reference, spatial relation, and/or SSB configuration(s), etc.). For example, the LMF 606 may send an NR Positioning Protocol A (NRPPa) positioning information request message to the serving base station 604 to request UL information for the UE 602.

At 614, the serving base station 604 may determine resources available for UL SRS, and at 616, the serving base station 604 may configure the UE 602 with one or more UL SRS resource sets based on the available resources. At 618, the serving base station 604 may provide UL SRS configuration information to the LMF 606, such as via an NRPPa positioning information response message. At 620, the LMF 606 may select one or more candidate neighbor BSs/TRPs 608, and the LMF 606 may provide an UL SRS configuration to the one or more candidate neighbor BSs/TRPs 608 and/or the serving base station 604, such as via an NRPPa measurement request message. The message may include information for enabling the one or more candidate neighbor BSs/TRPs 608 and/or the serving base station to perform the UL measurements.

At 622, the LMF 606 may send an LPP provide assistance data message to the UE 602. The message may include specified assistance data for the UE 602 to perform the DL measurements. At 624, the LMF 606 may send an LPP request location information message to the UE 602 to request multi-RTT measurements. At 626, for semi-persistent or aperiodic UL SRS, the LMF 606 may request the serving base station 604 to activate/trigger the UL SRS in the UE 602. For example, the LMF 606 may request activation of UE SRS transmission by sending an NRPPa positioning activation request message to the serving base station 604.

At 628, the serving base station 604 may activate the UE SRS transmission and send an NRPPa positioning activation response message. In response, the UE 602 may begin the UL-SRS transmission according to the time domain behavior of UL SRS resource configuration. At 630, the UE 602 may perform the DL measurements from the one or more candidate neighbor BSs/TRPs 608 and/or the serving base station 604 provided in the assistance data. At 632, each of the configured one or more candidate neighbor BSs/TRPs 608 and/or the serving base station 604 may perform the UL measurements. At 634, the UE 602 may report the DL measurements to the LMF 606, such as via an LPP provide location information message. At 636, each of the one or more candidate neighbor BSs/TRPs 608 and/or the serving base station 604 may report the UL measurements to the LMF 606, such as via an NRPPa measurement response message. At 638, the LMF 606 may determine the RTTs from the UE 602 and BS/TRP Rx-Tx time difference measurements for each of the one or more candidate neighbor BSs/TRPs 608 and/or the serving base station 604 for which corresponding UL and DL measurements were provided at 634 and 636, and the LMF 606 may calculate the position of the UE 602.

Some aspects of wireless communication may utilize different types of positioning reference signals (PRSs), such as downlink (DL) PRSs. PRSs are utilized by different wireless communications (e.g., new radio (NR)) and positioning methods in order to enable devices (e.g., UEs) to detect and measure different objects. For example, PRSs may enable UEs to detect and measure an increased about of neighbor TRPs or base stations. Several different types of positioning configurations are supported in wireless communications in order to enable a variety of deployments or environments for the devices or UEs (e.g., indoor environments, outdoor environments, sub-6 environments, mmW environments). Both UE-assisted positioning methods (e.g., calculations) and UE-based position methods are supported by different types of wireless communications (e.g., NR). Further, some types of positioning methods may be supported by specific types of wireless communication (e.g., NR). For instance, NR positioning methods may support at least one of: NR multiple round trip time (multi-RTT) positioning, NR downlink (DL) time difference of arrival (DL-TDOA) positioning, or NR DL angle of departure (DL-AoD) positioning.

In some aspects, different types of reference signals (e.g., downlink (DL) or uplink (UL) reference signals) and UE measurements may be utilized to facilitate the support of different positioning techniques. For example, DL PRSs and DL reference signal time difference (RSTD) UE measurements may facilitate support of DL-TDOA positioning. Also, DL PRSs and DL PRS reference signal received power (RSRP) UE measurements may facilitate support of DL-TDOA positioning, DL-AoD positioning, and/or multi-RTT positioning. Moreover, DL PRSs and sounding reference signals (SRS) for positioning and UE reception (Rx)-transmission (Tx) time different UE measurements may facilitate support of multi-RTT positioning. Further, synchronization signal blocks (SSBs) and channel state information (CSI)-reference signals (CSI-RSs) for radio resource management (RRM), as well as synchronization signal (SS)-RSRP (e.g., RSRP for RRM), SS-reference signal received quality (SS-RSRQ) (e.g., for RRM), CSI-RSRP (e.g., for RRM), and CSI-RSRP (e.g., for RRM), may facilitate support of enhanced-cell identifier (ID) (E-CID) positioning.

Different aspects of positioning may also utilize preconfigured DL PRS assistance data (AD). Preconfigured DL PRS AD may refer to the DL-PRS assistance data (with associated validity criteria) that may be provided to the UE (e.g., before or during an ongoing LTE positioning protocol (LPP) positioning session), to be then utilized for potential positioning measurements at a subsequent time (e.g., for deferred mobile terminated location request (MT-LR)). In some aspects, pre-configured DL-PRS assistance data may include multiple instances, where each instance may be applicable to a different area within the network. Also, each DL-PRS assistance data instance may be associated with an area ID. In some instances, the area ID may include a list of cells where the UE may be camped on/connected. Further, an applicable area ID at the UE location may be selected based on the cell where the UE is camped on/connected. The instance of the assistance data may be valid/selected if the UE is camped on/connected to one of the cells indicated within the list of cells in the area ID.

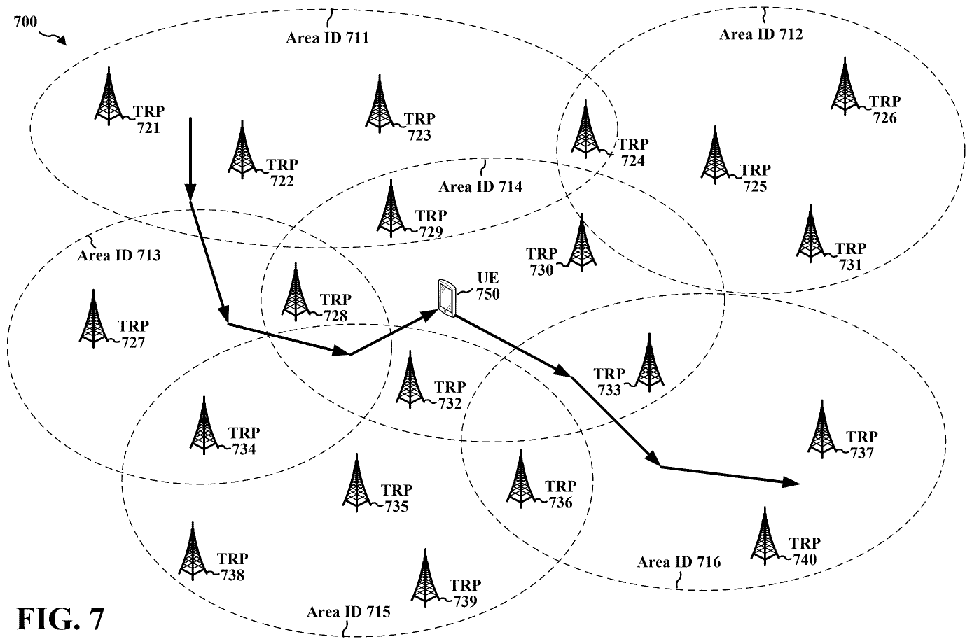

FIG. 7 is a diagram 700 illustrating example regions for positioning measurements. More specifically, FIG. 7 depicts a region for positioning measurements including a number of cells associated with an area identifier (ID). As shown in FIG. 7, diagram 700 includes a number of cells (i.e., the dashed-line ellipses in FIG. 7) and associated area IDs (e.g., area ID 711, area ID 712, area ID 713, area ID 714, area ID 715, and area ID 716). Diagram 700 also depicts a number of transmission-reception points (TRPs) within the areas (e.g., TRP 721, TRP 722, TRP 723, TRP 724, TRP 725, TRP 726, TRP 727, TRP 728, TRP 729, TRP 730, TRP 731, TRP 732, TRP 733, TRP 734, TRP 735, TRP 736, TRP 737, TRP 738, TRP 739, and TRP 740), as well as UE 750. As shown by the arrows in FIG. 7, UE 750 is gradually moving through the different cells and associated area IDs. That is, UE 750 starts in the cell corresponding to area ID 711, then moves to the cell corresponding to area ID 713, then moves to the cell corresponding to area ID 715, then moves to the cell corresponding to area ID 714, and then moves to the cell corresponding to area ID 716. The movement of UE 750 corresponds to the cell on which the UE 750 is camped on or connected. As indicated above, each of the area IDs in FIG. 7 may be associated with a DL-PRS assistance data instance for pre-configured DL-PRS assistance data.

In some aspects, there may be model performance variation for positioning methods or measurements. For instance, a neural network (NN)-based artificial intelligences (AI) or machine learning (ML) model may not be reliable. As ML may be considered a data-driven solution, the quality of the data may determine the performance of the downlink (DL) application. However, the realistic deployment environments may be more complicated than expected, and the performance of the deployed model may be worse. For example, in the model preparation stage (e.g., training/validation/testing), the prepared dataset may not cover all of the potential scenarios. So, model performance in the inference may largely vary in diverse environments. In order to ensure the performance, the system may monitor the model status, and be configured to optimize the model when the performance is worse. For example, in the model status monitoring, ML model outage detection may ensure a basic communication link. Also, a ML output may be verified (e.g., by value or traditional model/algorithm). If the output is likely wrong, the inference host may use a traditional model/algorithm instead. Further, some aspects of AI/ML model monitoring may include at least one of: periodical model status reporting, a UE triggering the model status reporting, a network triggering the UE report, model fallback, or network actions for the model update.

Additionally, in some aspects, there may be model switching for AI/ML models. As ML utilizes data-driven solutions, different ML models may be designed to adapt diverse conditions and tasks. For the flexible model management, the models may be grouped into different sets including different grouping rules. For example, the models may be grouped into different sets based on the model complexity. Also, the models may be grouped into different sets based on the model functions or tasks. For some groups, a network may need to trigger the group switching to adapt different conditions. In some instances, there may be many grouping rules, and the grouping may be based on one rule or the combination of some rules. In one case, one group may be mapped to a single ML model, where the group switching is equal to a single model configuration. If the conventional algorithms are grouped, the model group switching may also include the configuration between conventional algorithms and ML models.

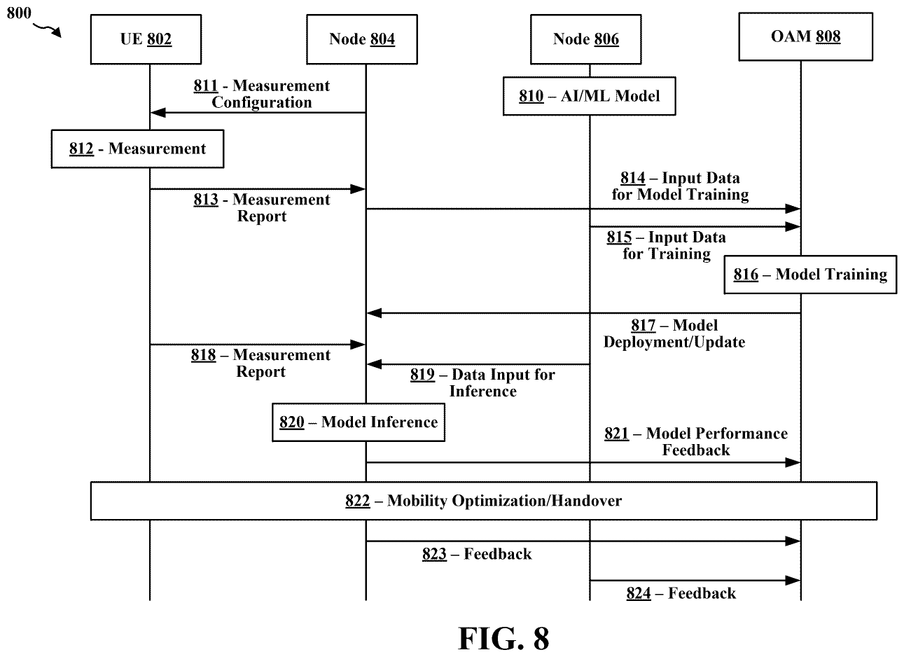

FIG. 8 is a diagram 800 illustrating an example communication flow for an AI/ML training procedure between a UE, a first node, a second node, and an operations, administration and maintenance (OAM) component. More specifically, FIG. 8 depicts UE 802 communicating with node 804 (e.g., a next generation (NG) radio access network (RAN) (NG-RAN) node, node 806 (e.g., an NG-RAN node, and OAM 808 (e.g., the OAM may be a third party or a location management function (LMF) within or outside the NG-RAN). As shown in FIG. 8, at 810, node 806 may perform an AI/ML model. At 811, node 804 may transmit a measurement configuration to the UE 802. At 812, UE 802 may perform a positioning measurement. Also, at 813, UE 802 may transmit a measurement report to the node 804. At 814, the node 804 may transmit input data for model training to the OAM 808. At 815, the node 806 may transmit input data for training to the OAM 808. At 816, the OAM 808 may perform model training. Further, at 817, the OAM 80 may transmit a model deployment or update to the node 804. At 818, the UE 802 may transmit a measurement report to the node 804. At 819, the node 806 may transmit a data input for inference to the node 804. At 820, the node 804 may perform the model inference. At 821, the node 806 may transmit the model performance feedback to the OAM 808. At 822, the UE 802, node 804, node 806, and OAM 808 may perform the mobility optimization/handover. At 823, the node 804 may transmit feedback to the OAM 808. Also, at 824, the node 806 may transmit feedback to the OAM 808.

In some aspects, a network entity (e.g., an LMF) may request one or more methods in a single request (e.g., a location information request (requestlocationinformation)). This location information request may include a number of types of location information. For example, the location information request may include: Global Navigation Satellite System (GNSS), Observed Time Difference Of Arrival (OTDOA), sensor measurements or other satellite position/location system, LTE signals, wireless local area network (WLAN) signals, Bluetooth signals, a terrestrial beacon system (TBS), sensor-based information (e.g., barometric pressure sensor, motion sensor), NR enhanced cell identifier (ID) (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Some types of positioning may utilize direct AI/ML positioning. For instance, direct AI/ML positioning may include details of the channel observation used as the input of the AI/ML model inference (e.g., type and size of model input), model input acquisition, and pre-processing. Other types of positioning may utilize AI/ML assisted positioning. For instance, AI/ML assisted positioning may include details of the channel observation used as the input of the AI/ML model inference (e.g., type and size of model input), model input acquisition, and pre-processing. Also, AI/ML assisted positioning may include details of the output of the AI/ML model inference, or how the AI/ML model output is used to obtain the UE's location.

In some aspects, different regions/sites may perform differently for given positioning methods. Indeed, there may be a tradeoff between power and positioning accuracy. For example, carrier phase measurements may perform better in line of sight, indoor scenarios and/or have huge performance loss. Also, the performance of TOA may be better compared to AOD and cooperative positioning (CP) in non-line-of-sight (NLOS). Based on training available to ML models, ML may outperform and/or underperform compared to legacy-based 5G positioning methods. Also, dilution of precision (DOP) may be different for different methods. Based on the above, it may be beneficial to having information about which positioning method will perform better for a given location. For instance, having this information may be beneficial to a UE/LMF to help select a suitable positioning method.

Aspects of the present disclosure may provide information regarding which positioning method will perform better for a given location. For instance, aspects presented herein may provide information regarding which positioning method will perform better for a given location in order to select a suitable positioning method. For example, aspects presented herein may provide a wireless device (e.g., a UE or LMF) information regarding which positioning method will perform better for a given location in order to select a suitable positioning method. By doing so, the wireless device (e.g., a UE or LMF) may select a suitable or ideal positioning method for a corresponding cell/area or area ID. In some instances, aspects presented herein may provide a request to perform a set of positioning methods for a set of area IDs associated with one or more cells/areas. Also, the set of positioning methods may correspond to one or more area IDs in the set of area IDs. Further, the wireless device (e.g., a UE or LMF) may perform at least one of the set of positioning methods based on the UE being within a certain cell area. Accordingly, a suitable or ideal positioning method may be performed for a corresponding cell/area or area ID. Thus, the wireless device (e.g., a UE or LMF) may save on power and/or performance during the positioning process.

Aspects presented herein may utilize a position method area ID for certain cells/areas. The positioning method area ID (PMAID) may be similar to an area ID, such that the PMAID may help to associated a certain cell area with corresponding positioning methods. For example, a PMAID may be list of serving cell ID or TRPs for which a UE may need to perform a same positioning method. In some instances, every PMAID may have the associated positioning method or list of positioning methods in a preference order. Also, multiple area IDs may belong to a single PMAID. Further, multiple PMAIDs may be defined within one area ID. In some aspects, area ID parameter (area-id) may be a field that specifies the area ID of the network area to which the TRPs in a cell ID list belong. Also, a cell ID list parameter (nr-cell-ID-List) may be a field that provide the cell IDs of the TRPs that belong to the network area identified by the area ID parameter.

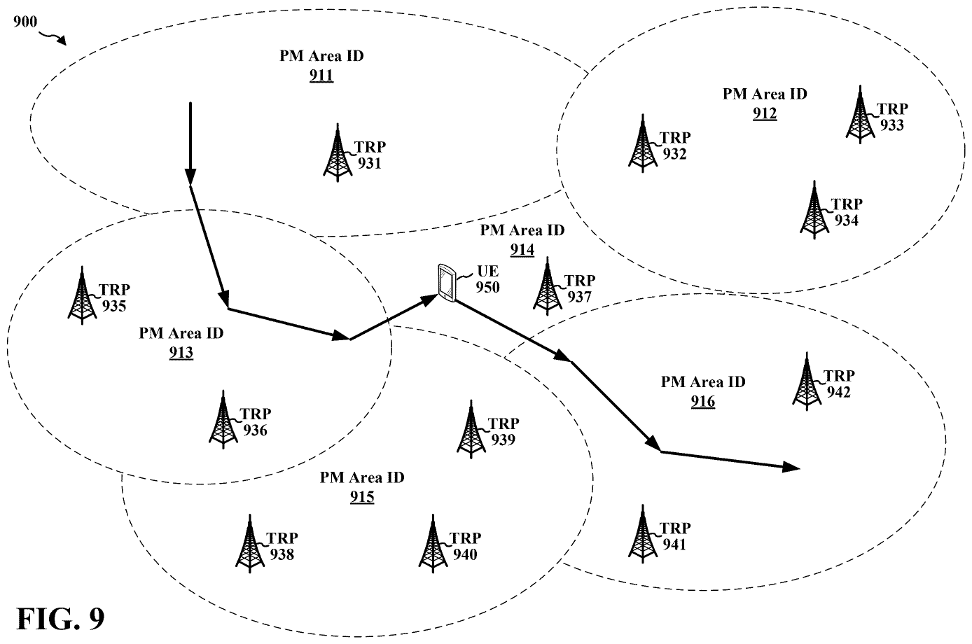

FIG. 9 is a diagram 900 illustrating example regions for positioning methods. More specifically, FIG. 9 depicts a region for positioning methods including a number of cells associated with an area identifier (ID) or positioning method (PM) area ID. As shown in FIG. 9, diagram 900 includes a number of cells (i.e., the dotted ellipses in FIG. 9) and associated area IDs or positioning method (PM) area IDs (e.g., PM area ID 911, PM area ID 912, PM area ID 913, PM area ID 914, PM area ID 915, and PM area ID 916). Diagram 900 also depicts a number of transmission-reception points (TRPs) within the areas (e.g., TRP 931, TRP 932, TRP 933, TRP 934, TRP 935, TRP 936, TRP 937, TRP 938, TRP 939, TRP 940, TRP 941, and TRP 942), as well as UE 950. As shown by the arrows in FIG. 9, UE 950 is gradually moving through the different cells and associated positioning method area IDs. That is, UE 950 starts in the cell corresponding to PM area ID 911, then moves to the cell corresponding to PM area ID 913, then moves to the cell corresponding to area ID 914, and then moves to the cell corresponding to area ID 916. The movement of UE 950 corresponds to the cell on which the UE 950 is camped on or connected. As indicated above, each of the PM area IDs in FIG. 9 may be associated with a positioning method for the corresponding cell. That is, as the UE 950 moves between the cells/area, it may be provided a corresponding PM area ID that will allow it to perform a positioning method(s) for the corresponding cell. For example, as UE 950 enters the cell corresponding to PM area ID 914, the UE 950 may perform the positioning method(s) for that cell.

Additionally, aspects of the present disclosure may provide positioning methods that are specific to certain area IDs (i.e., area-specific positioning methods). For instance, a network entity (e.g., LMF) may have the capability of configuring the area-specific positioning methods. The network entity (e.g., LMF) may configure multiple area IDs with positioning methods in the beginning of positioning sessions. The assistance data (AD) may be same or different between multiple positioning methods. Further, the UE may autonomously change the positioning methods after the area ID is changed. Also, the network entity (e.g., LMF) may configure one or more positioning methods for one or more positioning sessions.

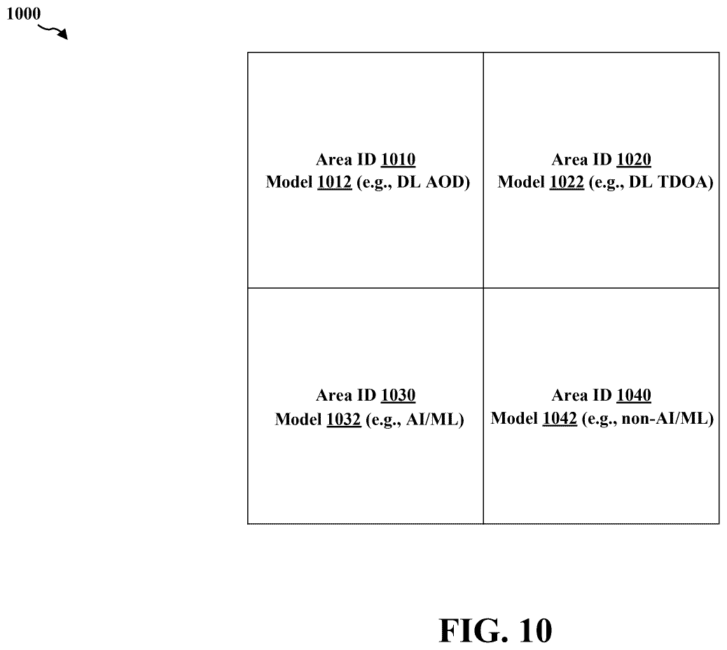

FIG. 10 is a diagram 1000 illustrating example regions for positioning methods. More specifically, FIG. 10 depicts a region for positioning methods including a number of cells associated with an area identifier (ID) or a model. As shown in FIG. 10, diagram 1000 includes a number of cells (i.e., the boxes in FIG. 10) and associated area IDs or positioning method (PM) area IDs (e.g., area ID 1010, area ID 1020, area ID 1030, and area ID 1040). Also, each of the area IDs may include a corresponding model or positioning method. For example, area ID 1010 may include model 1012 (e.g., DL AOD), area ID 1020 may include model 1022 (e.g., DL TDOA), area ID 1030 may include model 1032 (e.g., an AI/ML model), and area ID 1040 may include model 1042 (e.g., a non-AI/ML model).

In some instances, aspects presented herein may include area ID-based location information requests (e.g., RequestLocationInformation) for enabling multiple positioning methods. For example, UEs in one area (e.g., area 1) associated with an area ID (e.g., area ID 1) may need to perform certain positioning methods (e.g., LTE ODTOA along with NR-TDOA). Also, UEs in another area (e.g., area 2) associated with another area ID (e.g., area ID 2) may need to perform other positioning methods (e.g., GNSS along with NR-multi-RTT). Moreover, in some instances, aspects presented herein may include positioning method area ID-based location information requests (e.g., RequestLocationInformation) for enabling multiple positioning methods. For example, UEs in one area (e.g., area 1) associated with a positioning method area ID (e.g., PM area ID 1) may need to perform certain positioning methods (e.g., LTE ODTOA along with NR-TDOA). Further, UEs in another area (e.g., area 2) associated with another positioning method area ID (e.g., PM area ID 2) may need to perform other positioning methods (e.g., GNSS along with NR-multi-RTT). As part of assistance data, a UE may have the information regarding which positioning method may need to be enabled and reported in the given are ID or positioning method area ID.

In some instances, aspects presented herein may include an area ID change. For instance, aspects presented herein may allow for multiple positioning measurement reports in case there is an area ID change. For example, aspects presented herein may allow a positioning measurement per area ID or a positioning method per area ID. In one aspect, all the measurement reports may be sent at the end of the positioning sessions. In another aspect, the measurement reports may be sent after each area ID change within the positioning session.

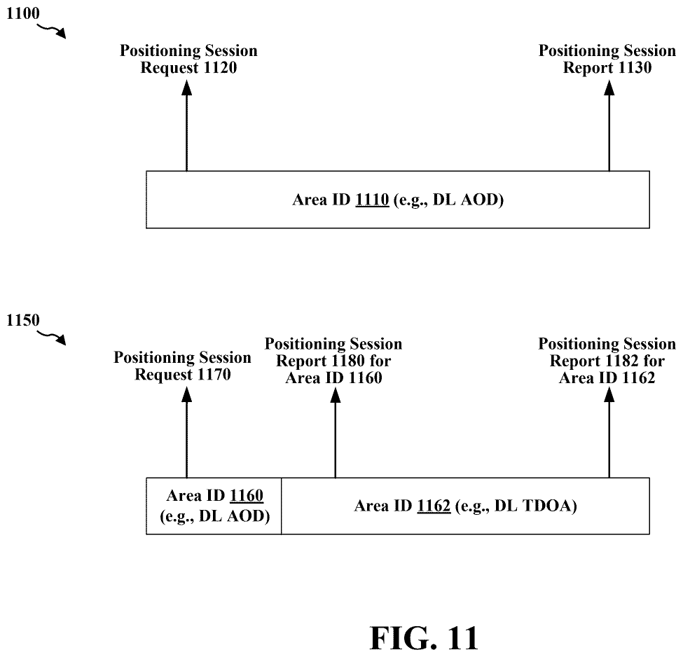

FIG. 11 includes diagram 1100 and diagram 1150 illustrating example report configurations for positioning sessions. More specifically, diagram 1100 depicts a report configuration where the measurement report may be sent at the end of the positioning session. Diagram 1100 includes area ID 1110 (e.g., DL AOD), positioning session request 1120, and positioning session report 1130. As shown in diagram 1100, positioning session report 1130 is sent at the end of the positioning session. Diagram 1150 depicts a report configuration where the measurement report may be sent after each area ID change within the positioning session. Diagram 1150 includes area ID 1160 (e.g., DL AOD), area ID 1162 (e.g., DL TDOA), positioning session request 1170, positioning session report 1180 for area ID 1160, and positioning session report 1182 for area ID 1162. As shown in diagram 1150, positioning session report 1180 is sent at the area ID change (i.e., after area ID 1160 and at the beginning of area ID 1162). Also, positioning session report 1182 is sent at the area ID change (i.e., near the end of area ID 1162.

Aspects presented herein may also include area ID specific positioning methods. For instance, a network entity (e.g., LMF) may have the capability of configuring the area specific AI/ML models for positioning sessions. The network entity (e.g., LMF) may configure multiple area IDs with AI/ML models at the beginning of the positioning sessions. Also, the UE may autonomously change the AI/ML methods after the corresponding area ID changes. Further, the network entity (e.g., LMF) may be able to associate an area ID with either direct AI/ML positioning or AI/ML-assisted positioning.

Aspects presented herein may also include area ID changes for corresponding UE capabilities. Based on the UE capabilities, a UE may run multiple AI/ML models for area ID changes during the positioning. In one aspect, for one UE capability, a UE may run one ML/AL model at given point in time. In another aspect, for another UE capability, a UE may run a maximum of two ML/AL models at given point in time. In yet another aspect, for yet another UE capability, a UE may run a maximum of three ML/AL models at given point in time. A UE may have the framework to report measurement report/positioning fixes through multiple ML/AI models. In one aspect, a UE may include a different report of each model. In one aspect, a UE may include one report with a model ID differentiation.

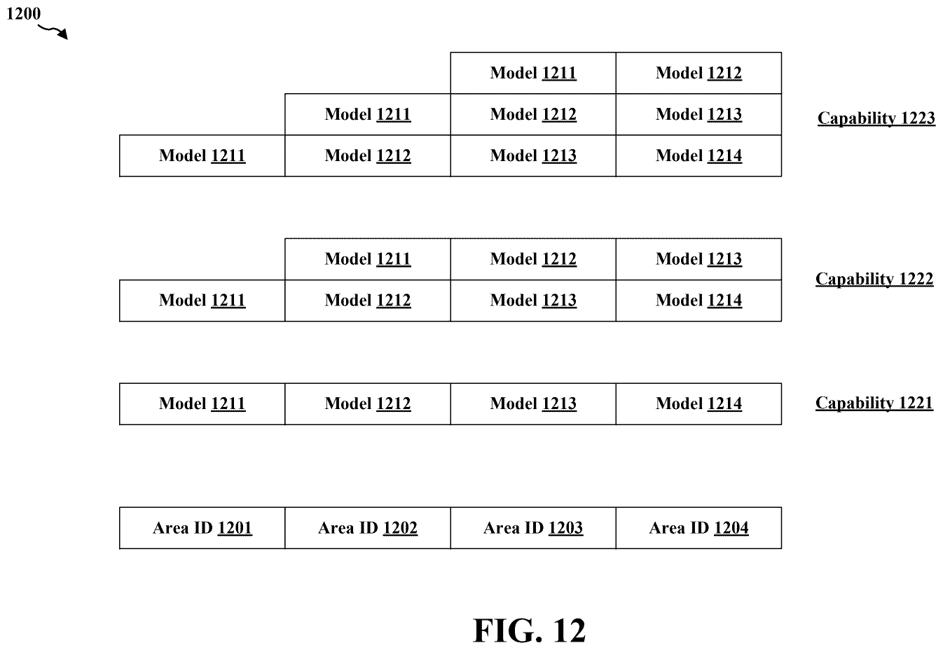

FIG. 12 includes diagram 1200 illustrating example positioning models for different UE capabilities. More specifically, diagram 1200 depicts AI/ML models for corresponding area IDs and different associated UE capabilities. As shown in FIG. 12, diagram 1200 depicts UE capability 1221 including model 1211 for area ID 1201, model 1212 for area ID 1202, model 1213 for area ID 1203, and model 1214 for area ID 1204. UE capability 1222 includes model 1211 for area ID 1201, model 1212 for area ID 1202, model 1213 for area ID 1203, and model 1214 for area ID 1204. Further, UE capability 1222 includes model 1211 for area ID 1202, model 1212 for area ID 1203, model 1213 for area ID 1204. UE capability 1223 includes model 1211 for area ID 1201, model 1212 for area ID 1202, model 1213 for area ID 1203, and model 1214 for area ID 1204. Also, UE capability 1223 includes model 1211 for area ID 1202, model 1212 for area ID 1203, model 1213 for area ID 1204. Moreover, Also, UE capability 1223 includes model 1211 for area ID 1203 and model 1212 for area ID 1204.

In some aspects, with more ML and AI models coming in the network entity (e.g., LMF) side as well as the UE side, and also based on the previous history positioning session, the UE/LMF may be in the position to recommend a suitable or favored positioning method for a given serving cell, cell ID, or area ID. For instance, a network entity (e.g., LMF) may provide a list of suitable or favored positioning methods or AI/ML models to a UE for a given serving cell, cell ID, or area ID. In some instances, the network entity may provide the list in a priority order. Additionally, in one aspects, a UE may provide a list of suitable or favored positioning methods or AI/ML model to the network entity for a given serving cell, TRP, or area ID. The UE may provide the list in a priority order. Also, the network entity may select the positioning method based on the priority for the corresponding area ID. Aspects of the present disclosure may include a number of benefits or advantages. For example, aspects of the present disclosure may provide information regarding which positioning method will perform better for a given location. For instance, aspects presented herein may provide information regarding which positioning method will perform better for a given location in order to select a suitable positioning method. For example, aspects presented herein may provide a wireless device (e.g., a UE or LMF) information regarding which positioning method will perform better for a given location in order to select a suitable positioning method. By doing so, the wireless device (e.g., a UE or LMF) may select a suitable or ideal positioning method for a corresponding cell/area or area ID. Further, a wireless device (e.g., a UE or LMF) may perform at least one of the set of positioning methods based on the UE being within a certain cell area. Accordingly, a suitable or ideal positioning method may be performed for a corresponding cell/area or area ID. As such, the wireless device (e.g., a UE or LMF) may save on power and/or performance during the positioning process.

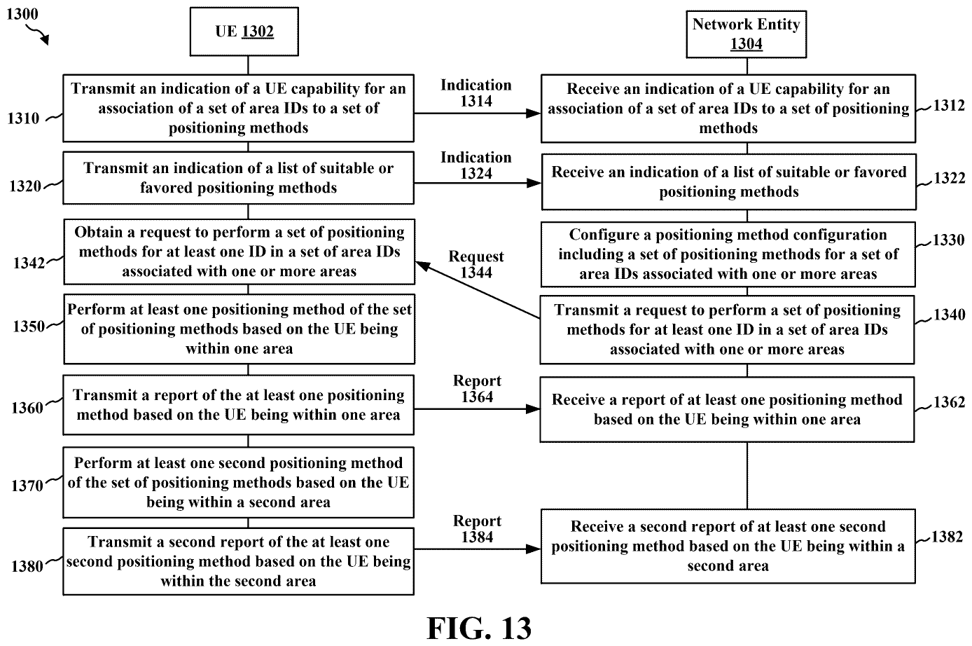

FIG. 13 is a communication flow diagram 1300 of wireless communication in accordance with one or more techniques of this disclosure. As shown in FIG. 13, diagram 900 includes example communications between UE 1302 (e.g., a UE or a wireless device) and a network entity 1304 (e.g., a server or an LMF), in accordance with one or more techniques of this disclosure. In some aspects, UE 1302 may be a first wireless device (e.g., UE, base station, TRP, or network entity) and network entity 1304 may be a second wireless device (e.g., UE, base station, TRP, or network entity).

At 1310, UE 1302 may transmit, for a network entity, an indication of a UE capability (e.g., indication 1314) for an association of a set of area IDs to a set of positioning methods, where a positioning method configuration is based on the indication of the UE capability. The indication of the UE capability may include an amount of artificial intelligence (AI)/machine learning (ML) models that the UE is capable of performing at a given time.

At 1312, network entity 1304 may receive, from a user equipment (UE), an indication of a UE capability (e.g., indication 1314) for an association of a set of area IDs to a set of positioning methods, where a positioning method configuration is configured based on the indication of the UE capability.

At 1320, UE 1302 may transmit an indication of a list of suitable or favored positioning methods (e.g., indication 1324), where a positioning method configuration is based on the list of suitable or favored positioning methods.

At 1322, network entity 1304 may receive an indication of a list of suitable or favored positioning methods (e.g., indication 1324), where a positioning method configuration is configured based on the list of suitable or favored positioning methods. The indication of the UE capability may include an amount of artificial intelligence (AI)/machine learning (ML) models that the UE is capable of performing at a given time.

At 1330, network entity 1304 may configure a positioning method configuration including a set of positioning methods for a set of area IDs associated with one or more areas, where each of the set of positioning methods corresponds to one or more area IDs in the set of area IDs, where the positioning method configuration includes information associated with a performance of the set of positioning methods.

At 1340, network entity 1304 may transmit, for a user equipment (UE), a request to perform the set of positioning methods for at least one area ID in the set of area IDs associated with the one or more areas (e.g., request 1344), where the request includes the positioning method configuration for the set of area IDs associated with the one or more areas. The request to perform the set of positioning methods may include a list of suitable or favored positioning methods for the set of area IDs. Also, the request to perform the set of positioning methods may correspond to a positioning session for the UE.

At 1342, UE 1302 may obtain a request to perform a set of positioning methods for at least one area identifier (ID) in a set of area IDs associated with one or more areas (e.g., request 1344), where the request includes a positioning method configuration for the set of area IDs associated with the one or more areas, where each of the set of positioning methods corresponds to one or more area IDs in the set of area IDs, where the positioning method configuration includes information associated with a performance of the set of positioning methods. The request to perform the set of positioning methods may include a list of suitable or favored positioning methods for the set of area IDs. Also, the request to perform the set of positioning methods may correspond to a positioning session for the UE.

In some aspects, each of the set of area IDs may be associated with one or more positioning methods in the set of positioning methods, such that each of the set of area IDs may be associated with a corresponding positioning method area ID in a set of positioning method area IDs, where each of the set of positioning method area IDs may correspond to a list of serving cell IDs or transmission-reception points (TRPs) associated with the one or more positioning methods. Also, the set of positioning methods may be associated with at least one of a set of artificial intelligence (AI)/machine learning (ML) models or a set of non-AI/ML models. Further, each of the set of AI/ML models may include a direct AI/ML model including a positioning estimate output or an AI/ML-assisted model including a positioning measurement output, where the positioning measurement output may include at least one of: a reference signal time difference (RSTD), a reception-transmission (RxTx) time difference, a line-of-sight (LoS) indication, a reference signal received power (RSRP), path RSRP, or a reference signal received quality (RSRQ), and where each of the set of non-AI/ML models includes at least one of: a time difference of arrival (TDOA), a round-trip time (RTT), an angle of departure (AoD), a global navigation satellite system (GNSS), or Bluetooth. In some instances, each of the set of area IDs may be associated with a corresponding location information request, where the corresponding location information request for each of the set of area IDs may enable multiple positioning methods of the set of positioning methods to be associated with the area ID. Each of the set of positioning methods may include at least one positioning measurement including one or more of: a reference signal time difference (RSTD), a reception-transmission (RxTx) time difference, a line-of-sight (LoS) indication, a reference signal received power (RSRP), a path RSRP, or a reference signal received quality (RSRQ).

At 1350, UE 1302 may perform at least one positioning method of the set of positioning methods based on the UE being within one area of the one or more areas associated with the set of area IDs. Also, the one area of the one or more areas corresponds to an area in which the UE is camped on a transmission-reception point (TRP) in a set of TRPs within the one or more areas.

At 1360, UE 1302 may transmit, for a network entity after the performance of the at least one positioning method, a report of the at least one positioning method based on the UE being within the one area of the one or more areas (e.g., report 1364). In some aspects, transmitting the report of the at least one positioning method may include: transmitting the report of the at least one positioning method at an end of a positioning session. That is, the UE may transmit the report of the at least one positioning method at an end of a positioning session. Also, transmitting the report of the at least one positioning method may include: transmitting the report of the at least one positioning method upon a change in one of the set of area IDs. That is, the UE may transmit the report of the at least one positioning method upon a change in one of the set of area IDs.

At 1362, network entity 1304 may receive a report of at least one positioning method of the set of positioning methods based on the UE being within one area of the one or more areas (e.g., report 1364). In some aspects, receiving the report of the at least one positioning method may include: receiving the report of the at least one positioning method at an end of a positioning session. That is, the network entity may receive the report of the at least one positioning method at an end of a positioning session. Also, receiving the report of the at least one positioning method may include: receiving the report of the at least one positioning method upon a change in one of the set of area IDs. That is, the network entity may receive the report of the at least one positioning method upon a change in one of the set of area IDs. Also, the one area of the one or more areas corresponds to an area in which the UE is camped on a transmission-reception point (TRP) in a set of TRPs within the one or more areas.

At 1370, UE 1302 may perform at least one second positioning method of the set of positioning methods based on the UE being within a second area of the one or more areas associated with the set of area IDs, where the at least one positioning method is different from the at least one second positioning method and a first area ID for the one area is different from a second area ID for the second area.

At 1380, UE 1302 may transmit a second report of the at least one second positioning method based on the UE being within the second area of the one or more areas (e.g., report 1384).

At 1382, network entity 1304 may receive a second report of at least one second positioning method of the set of positioning methods based on the UE being within a second area of the one or more areas, where the at least one positioning method is different from the at least one second positioning method and a first area ID for the one area is different from a second area ID for the second area (e.g., report 1384).

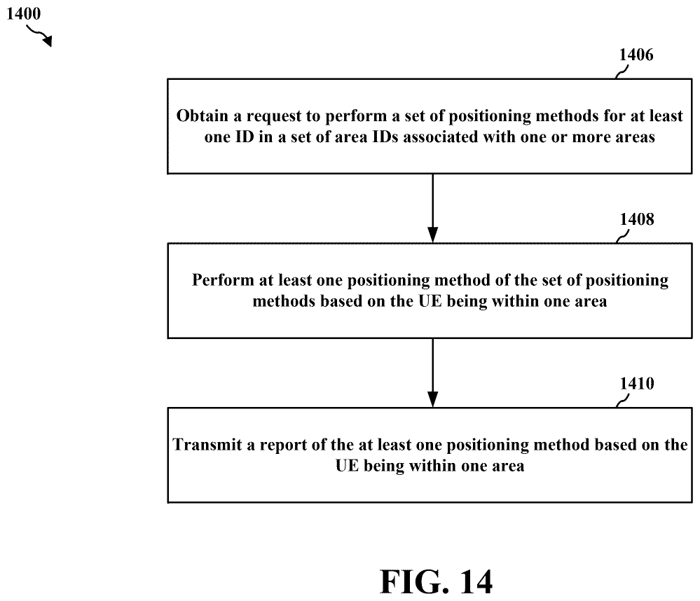

FIG. 14 is a flowchart 1400 of a method of wireless communication. The method may be performed by a wireless device or a UE (e.g., UE 104, UE 602, UE 750, UE 802, UE 950, UE 1302; apparatus 1804). The methods described herein may provide a number of benefits, such as improving resource utilization and/or power savings.

At 1406, the UE may obtain a request to perform a set of positioning methods for at least one area identifier (ID) in a set of area IDs associated with one or more areas, where the request includes a positioning method configuration for the set of area IDs associated with the one or more areas, where each of the set of positioning methods corresponds to one or more area IDs in the set of area IDs, where the positioning method configuration includes information associated with a performance of the set of positioning methods, as discussed with respect to FIGS. 4-13. For example, as described in 1342 of FIG. 13, the UE 1302 may obtain a request to perform a set of positioning methods for at least one area identifier (ID) in a set of area IDs associated with one or more areas, where the request includes a positioning method configuration for the set of area IDs associated with the one or more areas, where each of the set of positioning methods corresponds to one or more area IDs in the set of area IDs, where the positioning method configuration includes information associated with a performance of the set of positioning methods. Further, step 1406 may be performed by location component 198. The request to perform the set of positioning methods may include a list of suitable or favored positioning methods for the set of area IDs. Also, the request to perform the set of positioning methods may correspond to a positioning session for the UE.

In some aspects, each of the set of area IDs may be associated with one or more positioning methods in the set of positioning methods, such that each of the set of area IDs may be associated with a corresponding positioning method area ID in a set of positioning method area IDs, where each of the set of positioning method area IDs may correspond to a list of serving cell IDs or transmission-reception points (TRPs) associated with the one or more positioning methods. Also, the set of positioning methods may be associated with at least one of a set of artificial intelligence (AI)/machine learning (ML) models or a set of non-AI/ML models. Further, each of the set of AI/ML models may include a direct AI/ML model including a positioning estimate output or an AI/ML-assisted model including a positioning measurement output, where the positioning measurement output may include at least one of: a reference signal time difference (RSTD), a reception-transmission (RxTx) time difference, a line-of-sight (LoS) indication, a reference signal received power (RSRP), path RSRP, or a reference signal received quality (RSRQ), and where each of the set of non-AI/ML models includes at least one of: a time difference of arrival (TDOA), a round-trip time (RTT), an angle of departure (AoD), a global navigation satellite system (GNSS), or Bluetooth. In some instances, each of the set of area IDs may be associated with a corresponding location information request, where the corresponding location information request for each of the set of area IDs may enable multiple positioning methods of the set of positioning methods to be associated with the area ID. Each of the set of positioning methods may include at least one positioning measurement including one or more of: a reference signal time difference (RSTD), a reception-transmission (RxTx) time difference, a line-of-sight (LoS) indication, a reference signal received power (RSRP), a path RSRP, or a reference signal received quality (RSRQ).

At 1408, the UE may perform at least one positioning method of the set of positioning methods based on the UE being within one area of the one or more areas associated with the set of area IDs, as discussed with respect to FIGS. 4-13. For example, as described in 1350 of FIG. 13, the UE 1302 may perform at least one positioning method of the set of positioning methods based on the UE being within one area of the one or more areas associated with the set of area IDs. Further, step 1408 may be performed by location component 198. Also, the one area of the one or more areas corresponds to an area in which the UE is camped on a transmission-reception point (TRP) in a set of TRPs within the one or more areas.

At 1410, the UE may transmit, for a network entity after the performance of the at least one positioning method, a report of the at least one positioning method based on the UE being within the one area of the one or more areas, as discussed with respect to FIGS. 4-13. For example, as described in 1360 of FIG. 13, the UE 1302 may transmit, for a network entity after the performance of the at least one positioning method, a report of the at least one positioning method based on the UE being within the one area of the one or more areas. Further, step 1410 may be performed by location component 198. In some aspects, transmitting the report of the at least one positioning method may include: transmitting the report of the at least one positioning method at an end of a positioning session. That is, the UE may transmit the report of the at least one positioning method at an end of a positioning session. Also, transmitting the report of the at least one positioning method may include: transmitting the report of the at least one positioning method upon a change in one of the set of area IDs. That is, the UE may transmit the report of the at least one positioning method upon a change in one of the set of area IDs.

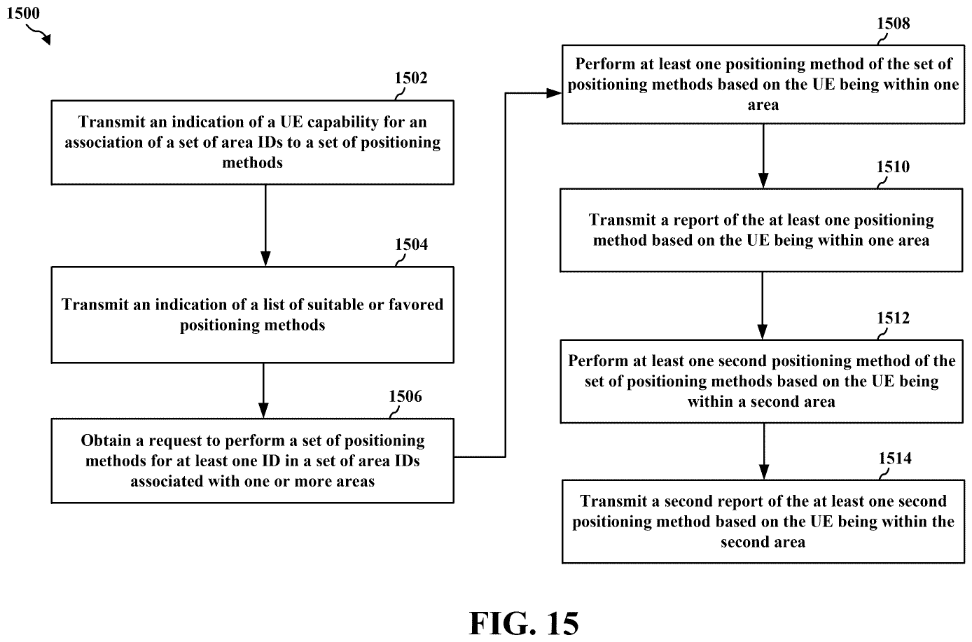

FIG. 15 is a flowchart 1500 of a method of wireless communication. The method may be performed by a wireless device or a UE (e.g., UE 104, UE 602, UE 750, UE 802, UE 950, UE 1302; apparatus 1804). The methods described herein may provide a number of benefits, such as improving resource utilization and/or power savings.

At 1502, the UE may transmit, for a network entity, an indication of a UE capability for an association of a set of area IDs to a set of positioning methods, where a positioning method configuration is based on the indication of the UE capability, as discussed with respect to FIGS. 4-13. For example, as described in 1310 of FIG. 13, the UE 1302 may transmit, for a network entity, an indication of a UE capability for an association of a set of area IDs to a set of positioning methods, where a positioning method configuration is based on the indication of the UE capability. Further, step 1502 may be performed by location component 198. The indication of the UE capability may include an amount of artificial intelligence (AI)/machine learning (ML) models that the UE is capable of performing at a given time.

At 1504, the UE may transmit an indication of a list of suitable or favored positioning methods, where a positioning method configuration is based on the list of suitable or favored positioning methods, as discussed with respect to FIGS. 4-13. For example, as described in 1320 of FIG. 13, the UE 1302 may transmit an indication of a list of suitable or favored positioning methods, where a positioning method configuration is based on the list of suitable or favored positioning methods. Further, step 1504 may be performed by location component 198.

At 1506, the UE may obtain a request to perform a set of positioning methods for at least one area identifier (ID) in a set of area IDs associated with one or more areas, where the request includes a positioning method configuration for the set of area IDs associated with the one or more areas, where each of the set of positioning methods corresponds to one or more area IDs in the set of area IDs, where the positioning method configuration includes information associated with a performance of the set of positioning methods, as discussed with respect to FIGS. 4-13. For example, as described in 1342 of FIG. 13, the UE 1302 may obtain a request to perform a set of positioning methods for at least one area identifier (ID) in a set of area IDs associated with one or more areas, where the request includes a positioning method configuration for the set of area IDs associated with the one or more areas, where each of the set of positioning methods corresponds to one or more area IDs in the set of area IDs, where the positioning method configuration includes information associated with a performance of the set of positioning methods. Further, step 1506 may be performed by location component 198. The request to perform the set of positioning methods may include a list of suitable or favored positioning methods for the set of area IDs. Also, the request to perform the set of positioning methods may correspond to a positioning session for the UE.

In some aspects, each of the set of area IDs may be associated with one or more positioning methods in the set of positioning methods, such that each of the set of area IDs may be associated with a corresponding positioning method area ID in a set of positioning method area IDs, where each of the set of positioning method area IDs may correspond to a list of serving cell IDs or transmission-reception points (TRPs) associated with the one or more positioning methods. Also, the set of positioning methods may be associated with at least one of a set of artificial intelligence (AI)/machine learning (ML) models or a set of non-AI/ML models. Further, each of the set of AI/ML models may include a direct AI/ML model including a positioning estimate output or an AI/ML-assisted model including a positioning measurement output, where the positioning measurement output may include at least one of: a reference signal time difference (RSTD), a reception-transmission (RxTx) time difference, a line-of-sight (LoS) indication, a reference signal received power (RSRP), path RSRP, or a reference signal received quality (RSRQ), and where each of the set of non-AI/ML models includes at least one of: a time difference of arrival (TDOA), a round-trip time (RTT), an angle of departure (AoD), a global navigation satellite system (GNSS), or Bluetooth. In some instances, each of the set of area IDs may be associated with a corresponding location information request, where the corresponding location information request for each of the set of area IDs may enable multiple positioning methods of the set of positioning methods to be associated with the area ID. Each of the set of positioning methods may include at least one positioning measurement including one or more of: a reference signal time difference (RSTD), a reception-transmission (RxTx) time difference, a line-of-sight (LoS) indication, a reference signal received power (RSRP), a path RSRP, or a reference signal received quality (RSRQ).

At 1508, the UE may perform at least one positioning method of the set of positioning methods based on the UE being within one area of the one or more areas associated with the set of area IDs, as discussed with respect to FIGS. 4-13. For example, as described in 1350 of FIG. 13, the UE 1302 may perform at least one positioning method of the set of positioning methods based on the UE being within one area of the one or more areas associated with the set of area IDs. Further, step 1508 may be performed by location component 198. Also, the one area of the one or more areas corresponds to an area in which the UE is camped on a transmission-reception point (TRP) in a set of TRPs within the one or more areas.

At 1510, the UE may transmit, for a network entity after the performance of the at least one positioning method, a report of the at least one positioning method based on the UE being within the one area of the one or more areas, as discussed with respect to FIGS. 4-13. For example, as described in 1360 of FIG. 13, the UE 1302 may transmit, for a network entity after the performance of the at least one positioning method, a report of the at least one positioning method based on the UE being within the one area of the one or more areas. Further, step 1510 may be performed by location component 198. In some aspects, transmitting the report of the at least one positioning method may include: transmitting the report of the at least one positioning method at an end of a positioning session. That is, the UE may transmit the report of the at least one positioning method at an end of a positioning session. Also, transmitting the report of the at least one positioning method may include: transmitting the report of the at least one positioning method upon a change in one of the set of area IDs. That is, the UE may transmit the report of the at least one positioning method upon a change in one of the set of area IDs.

At 1512, the UE may perform at least one second positioning method of the set of positioning methods based on the UE being within a second area of the one or more areas associated with the set of area IDs, where the at least one positioning method is different from the at least one second positioning method and a first area ID for the one area is different from a second area ID for the second area, as discussed with respect to FIGS. 4-13. For example, as described in 1370 of FIG. 13, the UE 1302 may perform at least one second positioning method of the set of positioning methods based on the UE being within a second area of the one or more areas associated with the set of area IDs, where the at least one positioning method is different from the at least one second positioning method and a first area ID for the one area is different from a second area ID for the second area. Further, step 1512 may be performed by location component 198.

At 1514, the UE may transmit a second report of the at least one second positioning method based on the UE being within the second area of the one or more areas, as discussed with respect to FIGS. 4-13. For example, as described in 1380 of FIG. 13, the UE 1302 may transmit a second report of the at least one second positioning method based on the UE being within the second area of the one or more areas. Further, step 1514 may be performed by location component 198.

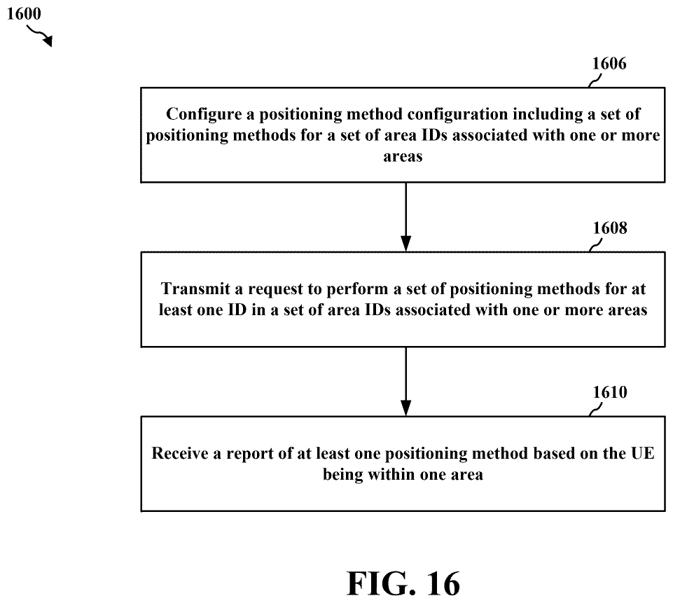

FIG. 16 is a flowchart 1600 of a method of wireless communication. The method may be performed by a network entity, a server, or an LMF (e.g., LMF 166; set of locations servers 168; LMF 606; network entity 1304; network entity 1902; network entity 2060). The methods described herein may provide a number of benefits, such as improving resource utilization and/or power savings.

At 1606, the network entity may configure a positioning method configuration including a set of positioning methods for a set of area IDs associated with one or more areas, where each of the set of positioning methods corresponds to one or more area IDs in the set of area IDs, where the positioning method configuration includes information associated with a performance of the set of positioning methods, as discussed with respect to FIGS. 4-13. For example, as described in 1330 of FIG. 13, network entity 1304 may configure a positioning method configuration including a set of positioning methods for a set of area IDs associated with one or more areas, where each of the set of positioning methods corresponds to one or more area IDs in the set of area IDs, where the positioning method configuration includes information associated with a performance of the set of positioning methods. Further, step 1606 may be performed by location component 199.

At 1608, the network entity may transmit, for a user equipment (UE), a request to perform the set of positioning methods for at least one area ID in the set of area IDs associated with the one or more areas, where the request includes the positioning method configuration for the set of area IDs associated with the one or more areas, as discussed with respect to FIGS. 4-13. For example, as described in 1340 of FIG. 13, network entity 1304 may transmit, for a user equipment (UE), a request to perform the set of positioning methods for at least one area ID in the set of area IDs associated with the one or more areas, where the request includes the positioning method configuration for the set of area IDs associated with the one or more areas. Further, step 1608 may be performed by location component 199. The request to perform the set of positioning methods may include a list of suitable or favored positioning methods for the set of area IDs. Also, the request to perform the set of positioning methods may correspond to a positioning session for the UE.

In some aspects, each of the set of area IDs may be associated with one or more positioning methods in the set of positioning methods, such that each of the set of area IDs may be associated with a corresponding positioning method area ID in a set of positioning method area IDs, where each of the set of positioning method area IDs may correspond to a list of serving cell IDs or transmission-reception points (TRPs) associated with the one or more positioning methods. Also, the set of positioning methods may be associated with at least one of a set of artificial intelligence (AI)/machine learning (ML) models or a set of non-AI/ML models. Further, each of the set of AI/ML models may include a direct AI/ML model including a positioning estimate output or an AI/ML-assisted model including a positioning measurement output, where the positioning measurement output may include at least one of: a reference signal time difference (RSTD), a reception-transmission (RxTx) time difference, a line-of-sight (LoS) indication, a reference signal received power (RSRP), path RSRP, or a reference signal received quality (RSRQ), and where each of the set of non-AI/ML models includes at least one of: a time difference of arrival (TDOA), a round-trip time (RTT), an angle of departure (AoD), a global navigation satellite system (GNSS), or Bluetooth. In some instances, each of the set of area IDs may be associated with a corresponding location information request, where the corresponding location information request for each of the set of area IDs may enable multiple positioning methods of the set of positioning methods to be associated with the area ID. Each of the set of positioning methods may include at least one positioning measurement including one or more of: a reference signal time difference (RSTD), a reception-transmission (RxTx) time difference, a line-of-sight (LoS) indication, a reference signal received power (RSRP), a path RSRP, or a reference signal received quality (RSRQ).

At 1610, the network entity may receive a report of at least one positioning method of the set of positioning methods based on the UE being within one area of the one or more areas, as discussed with respect to FIGS. 4-13. For example, as described in 1362 of FIG. 13, network entity 1304 may receive a report of at least one positioning method of the set of positioning methods based on the UE being within one area of the one or more areas. Further, step 1610 may be performed by location component 199. In some aspects, receiving the report of the at least one positioning method may include: receiving the report of the at least one positioning method at an end of a positioning session. That is, the network entity may receive the report of the at least one positioning method at an end of a positioning session. Also, receiving the report of the at least one positioning method may include: receiving the report of the at least one positioning method upon a change in one of the set of area IDs. That is, the network entity may receive the report of the at least one positioning method upon a change in one of the set of area IDs. Also, the one area of the one or more areas corresponds to an area in which the UE is camped on a transmission-reception point (TRP) in a set of TRPs within the one or more areas.

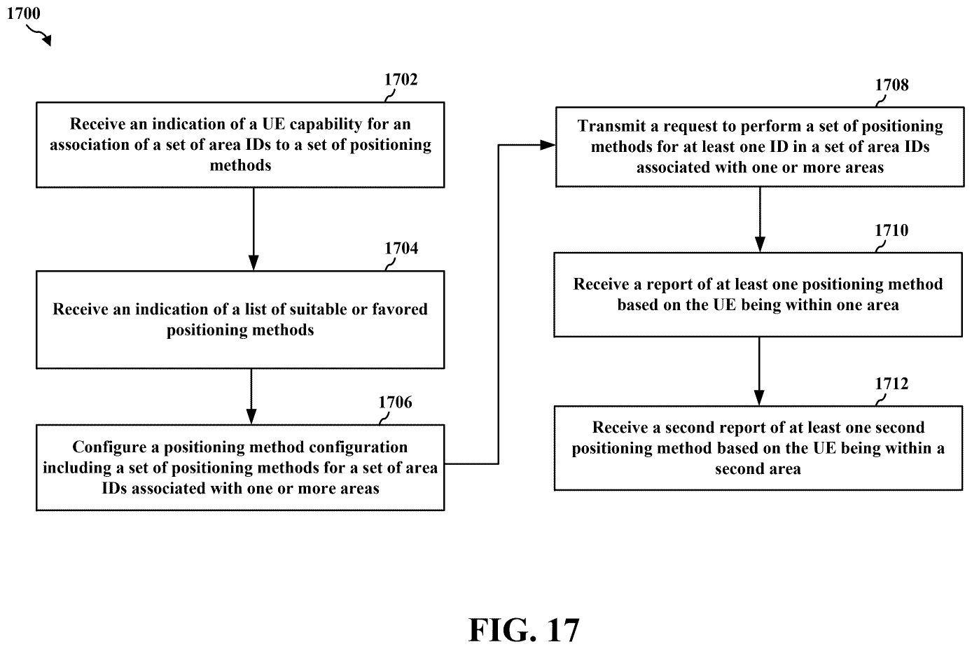

FIG. 17 is a flowchart 1700 of a method of wireless communication. The method may be performed by a network entity, a server, or an LMF (e.g., LMF 166; set of locations servers 168; LMF 606; network entity 1304; network entity 1902; network entity 2060). The methods described herein may provide a number of benefits, such as improving resource utilization and/or power savings.

At 1702, the network entity may receive, from a user equipment (UE), an indication of a UE capability for an association of a set of area IDs to a set of positioning methods, where a positioning method configuration is configured based on the indication of the UE capability, as discussed with respect to FIGS. 4-13. For example, as described in 1312 of FIG. 13, network entity 1304 may receive, from a user equipment (UE), an indication of a UE capability for an association of a set of area IDs to a set of positioning methods, where a positioning method configuration is configured based on the indication of the UE capability. Further, step 1702 may be performed by location component 199.

At 1704, the network entity may receive an indication of a list of suitable or favored positioning methods, where a positioning method configuration is configured based on the list of suitable or favored positioning methods, as discussed with respect to FIGS. 4-13. For example, as described in 1322 of FIG. 13, network entity 1304 may receive an indication of a list of suitable or favored positioning methods, where a positioning method configuration is configured based on the list of suitable or favored positioning methods. Further, step 1704 may be performed by location component 199. The indication of the UE capability may include an amount of artificial intelligence (AI)/machine learning (ML) models that the UE is capable of performing at a given time.

At 1706, the network entity may configure a positioning method configuration including a set of positioning methods for a set of area IDs associated with one or more areas, where each of the set of positioning methods corresponds to one or more area IDs in the set of area IDs, where the positioning method configuration includes information associated with a performance of the set of positioning methods, as discussed with respect to FIGS. 4-13. For example, as described in 1330 of FIG. 13, network entity 1304 may configure a positioning method configuration including a set of positioning methods for a set of area IDs associated with one or more areas, where each of the set of positioning methods corresponds to one or more area IDs in the set of area IDs, where the positioning method configuration includes information associated with a performance of the set of positioning methods. Further, step 1706 may be performed by location component 199.

At 1708, the network entity may transmit, for a user equipment (UE), a request to perform the set of positioning methods for at least one area ID in the set of area IDs associated with the one or more areas, where the request includes the positioning method configuration for the set of area IDs associated with the one or more areas, as discussed with respect to FIGS. 4-13. For example, as described in 1340 of FIG. 13, network entity 1304 may transmit, for a user equipment (UE), a request to perform the set of positioning methods for at least one area ID in the set of area IDs associated with the one or more areas, where the request includes the positioning method configuration for the set of area IDs associated with the one or more areas. Further, step 1708 may be performed by location component 199. The request to perform the set of positioning methods may include a list of suitable or favored positioning methods for the set of area IDs. Also, the request to perform the set of positioning methods may correspond to a positioning session for the UE.

In some aspects, each of the set of area IDs may be associated with one or more positioning methods in the set of positioning methods, such that each of the set of area IDs may be associated with a corresponding positioning method area ID in a set of positioning method area IDs, where each of the set of positioning method area IDs may correspond to a list of serving cell IDs or transmission-reception points (TRPs) associated with the one or more positioning methods. Also, the set of positioning methods may be associated with at least one of a set of artificial intelligence (AI)/machine learning (ML) models or a set of non-AI/ML models. Further, each of the set of AI/ML models may include a direct AI/ML model including a positioning estimate output or an AI/ML-assisted model including a positioning measurement output, where the positioning measurement output may include at least one of: a reference signal time difference (RSTD), a reception-transmission (RxTx) time difference, a line-of-sight (LoS) indication, a reference signal received power (RSRP), path RSRP, or a reference signal received quality (RSRQ), and where each of the set of non-AI/ML models includes at least one of: a time difference of arrival (TDOA), a round-trip time (RTT), an angle of departure (AoD), a global navigation satellite system (GNSS), or Bluetooth. In some instances, each of the set of area IDs may be associated with a corresponding location information request, where the corresponding location information request for each of the set of area IDs may enable multiple positioning methods of the set of positioning methods to be associated with the area ID. Each of the set of positioning methods may include at least one positioning measurement including one or more of: a reference signal time difference (RSTD), a reception-transmission (RxTx) time difference, a line-of-sight (LoS) indication, a reference signal received power (RSRP), a path RSRP, or a reference signal received quality (RSRQ).

At 1710, the network entity may receive a report of at least one positioning method of the set of positioning methods based on the UE being within one area of the one or more areas, as discussed with respect to FIGS. 4-13. For example, as described in 1362 of FIG. 13, network entity 1304 may receive a report of at least one positioning method of the set of positioning methods based on the UE being within one area of the one or more areas. Further, step 1710 may be performed by location component 199. In some aspects, receiving the report of the at least one positioning method may include: receiving the report of the at least one positioning method at an end of a positioning session. That is, the network entity may receive the report of the at least one positioning method at an end of a positioning session. Also, receiving the report of the at least one positioning method may include: receiving the report of the at least one positioning method upon a change in one of the set of area IDs. That is, the network entity may receive the report of the at least one positioning method upon a change in one of the set of area IDs. Also, the one area of the one or more areas corresponds to an area in which the UE is camped on a transmission-reception point (TRP) in a set of TRPs within the one or more areas.

At 1712, the network entity may receive a second report of at least one second positioning method of the set of positioning methods based on the UE being within a second area of the one or more areas, where the at least one positioning method is different from the at least one second positioning method and a first area ID for the one area is different from a second area ID for the second area, as discussed with respect to FIGS. 4-13. For example, as described in 1382 of FIG. 13, network entity 1304 may receive a second report of at least one second positioning method of the set of positioning methods based on the UE being within a second area of the one or more areas, where the at least one positioning method is different from the at least one second positioning method and a first area ID for the one area is different from a second area ID for the second area. Further, step 1712 may be performed by location component 199.

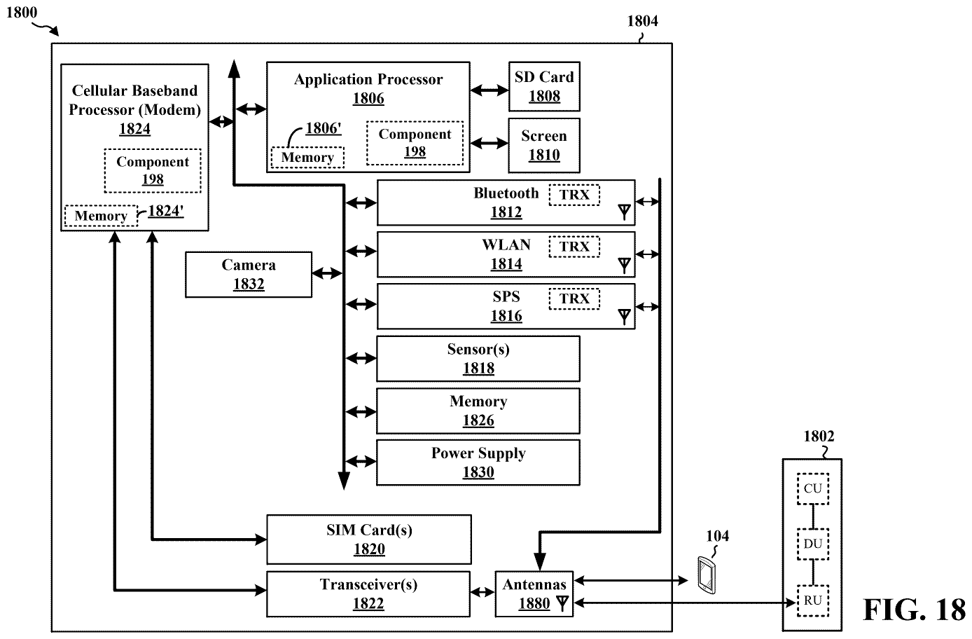

FIG. 18 is a diagram 1800 illustrating an example of a hardware implementation for an apparatus 1804. The apparatus 1804 may be a UE, a component of a UE, or may implement UE functionality. In some aspects, the apparatus 1804 may include a cellular baseband processor 1824 (also referred to as a modem) coupled to one or more transceivers 1822 (e.g., cellular RF transceiver). The cellular baseband processor 1824 may include on-chip memory 1824′. In some aspects, the apparatus 1804 may further include one or more subscriber identity modules (SIM) cards 1820 and an application processor 1806 coupled to a secure digital (SD) card 1808 and a screen 1810. The application processor 1806 may include on-chip memory 1806′. In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; motion sensor such as inertial management unit (IMU), gyroscope, and/or accelerometer(s); magnetometer, audio and/or other technologies used for positioning), additional memory modules 1826, a power supply 1830, and/or a camera 1832. The Bluetooth module 1812, the WLAN module 1814, and the SPS module 1816 may include an on-chip transceiver (TRX) (or in some cases, just a receiver (RX)). The Bluetooth module 1812, the WLAN module 1814, and the SPS module 1816 may include their own dedicated antennas and/or utilize the antennas 1880 for communication. The cellular baseband processor 1824 communicates through the transceiver(s) 1822 via one or more antennas 1880 with the UE 104 and/or with an RU associated with a network entity 1802. The cellular baseband processor 1824 and the application processor 1806 may each include a computer-readable medium/memory 1824′, 1806′, respectively. The additional memory modules 1826 may also be considered a computer-readable medium/memory. Each computer-readable medium/memory 1824′, 1806′, 1826 may be non-transitory. The cellular baseband processor 1824 and the application processor 1806 are each responsible for general processing, including the execution of software stored on the computer-readable medium/memory. The software, when executed by the cellular baseband processor 1824/application processor 1806, causes the cellular baseband processor 1824/application processor 1806 to perform the various functions described supra. The computer-readable medium/memory may also be used for storing data that is manipulated by the cellular baseband processor 1824/application processor 1806 when executing software. The cellular baseband processor 1824/application processor 1806 may be a component of the UE 350 and may include the memory 360 and/or at least one of the TX processor 368, the RX processor 356, and the controller/processor 359. In one configuration, the apparatus 1804 may be a processor chip (modem and/or application) and include just the cellular baseband processor 1824 and/or the application processor 1806, and in another configuration, the apparatus 1804 may be the entire UE (e.g., see 350 of FIG. 3) and include the additional modules of the apparatus 1804.

As discussed supra, the location component 198 may be configured to obtain a request to perform a set of positioning methods for at least one area identifier (ID) in a set of area IDs associated with one or more areas, where the request includes a positioning method configuration for the set of area IDs associated with the one or more areas, where each of the set of positioning methods corresponds to one or more area IDs in the set of area IDs, where the positioning method configuration includes information associated with a performance of the set of positioning methods. The location component 198 may also be configured to perform at least one positioning method of the set of positioning methods based on the UE being within one area of the one or more areas associated with the set of area IDs. The location component 198 may also be configured to transmit, for a network entity after the performance of the at least one positioning method, a report of the at least one positioning method based on the UE being within the one area of the one or more areas. The location component 198 may also be configured to perform at least one second positioning method of the set of positioning methods based on the UE being within a second area of the one or more areas associated with the set of area IDs, where the at least one positioning method is different from the at least one second positioning method and a first area ID for the one area is different from a second area ID for the second area. The location component 198 may also be configured to transmit a second report of the at least one second positioning method based on the UE being within the second area of the one or more areas. The location component 198 may also be configured to transmit an indication of a list of suitable or favored positioning methods, where the positioning method configuration is based on the list of suitable or favored positioning methods. The location component 198 may also be configured to transmit, for the network entity, an indication of a UE capability for an association of the set of area IDs to the set of positioning methods, where the positioning method configuration is based on the indication of the UE capability.

The location component 198 may be within the cellular baseband processor 1824, the application processor 1806, or both the cellular baseband processor 1824 and the application processor 1806. The location component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1804 may include a variety of components configured for various functions. In one configuration, the apparatus 1804, and in particular the cellular baseband processor 1824 and/or the application processor 1806, includes means for obtaining a request to perform a set of positioning methods for at least one area identifier (ID) in a set of area IDs associated with one or more areas, where the request includes a positioning method configuration for the set of area IDs associated with the one or more areas, where each of the set of positioning methods corresponds to one or more area IDs in the set of area IDs, where the positioning method configuration includes information associated with a performance of the set of positioning methods. The apparatus 1804 may also include means for performing at least one positioning method of the set of positioning methods based on the UE being within one area of the one or more areas associated with the set of area IDs. The apparatus 1804 may also include means for transmitting, for a network entity after the performance of the at least one positioning method, a report of the at least one positioning method based on the UE being within the one area of the one or more areas. The apparatus 1804 may also include means for performing at least one second positioning method of the set of positioning methods based on the UE being within a second area of the one or more areas associated with the set of area IDs, where the at least one positioning method is different from the at least one second positioning method and a first area ID for the one area is different from a second area ID for the second area. The apparatus 1804 may also include means for transmitting a second report of the at least one second positioning method based on the UE being within the second area of the one or more areas. The apparatus 1804 may also include means for transmitting an indication of a list of suitable or favored positioning methods, where the positioning method configuration is based on the list of suitable or favored positioning methods. The apparatus 1804 may also include means for transmitting, for the network entity, an indication of a UE capability for an association of the set of area IDs to the set of positioning methods, where the positioning method configuration is based on the indication of the UE capability. The means may be the location component 198 of the apparatus 1804 configured to perform the functions recited by the means. As described supra, the apparatus 1804 may include the TX processor 368, the RX processor 356, and the controller/processor 359. As such, in one configuration, the means may be the TX processor 368, the RX processor 356, and/or the controller/processor 359 configured to perform the functions recited by the means.

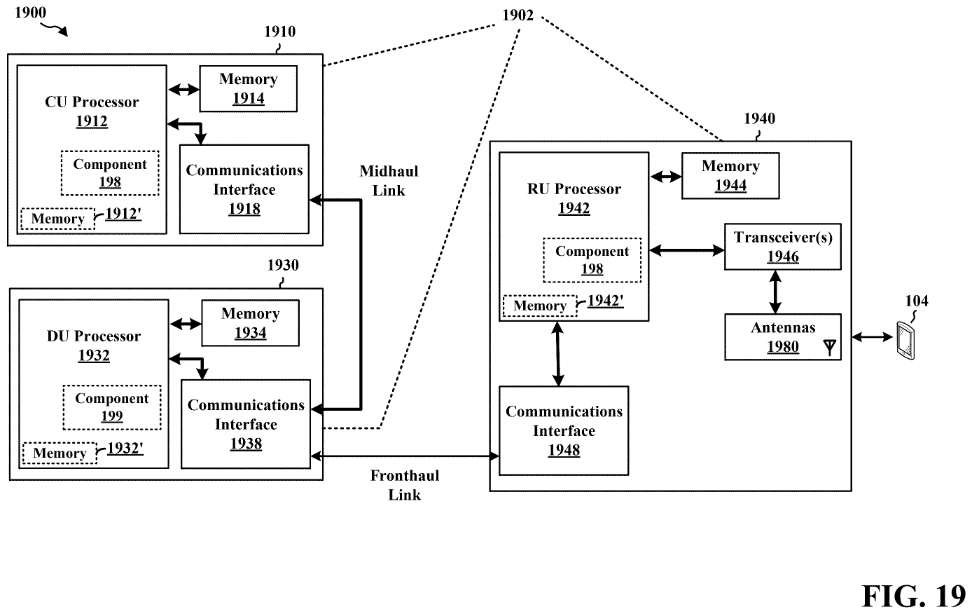

FIG. 19 is a diagram 1900 illustrating an example of a hardware implementation for a network entity 1902. The network entity 1902 may be a BS, a component of a BS, or may implement BS functionality. The network entity 1902 may include at least one of a CU 1910, a DU 1930, or an RU 1940. For example, depending on the layer functionality handled by the location component 198, the network entity 1902 may include the CU 1910; both the CU 1910 and the DU 1930; each of the CU 1910, the DU 1930, and the RU 1940; the DU 1930; both the DU 1930 and the RU 1940; or the RU 1940. The CU 1910 may include a CU processor 1912. The CU processor 1912 may include on-chip memory 1912′. In some aspects, the CU 1910 may further include additional memory modules 1914 and a communications interface 1918. The CU 1910 communicates with the DU 1930 through a midhaul link, such as an F1 interface. The DU 1930 may include a DU processor 1932. The DU processor 1932 may include on-chip memory 1932′. In some aspects, the DU 1930 may further include additional memory modules 1934 and a communications interface 1938. The DU 1930 communicates with the RU 1940 through a fronthaul link. The RU 1940 may include an RU processor 1942. The RU processor 1942 may include on-chip memory 1942′. In some aspects, the RU 1940 may further include additional memory modules 1944, one or more transceivers 1946, antennas 1980, and a communications interface 1948. The RU 1940 communicates with the UE 104. The on-chip memory 1912′, 1932′, 1942′ and the additional memory modules 1914, 1934, 1944 may each be considered a computer-readable medium/memory. Each computer-readable medium/memory may be non-transitory. Each of the processors 1912, 1932, 1942 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the location component 198 may be configured to configure a positioning method configuration including a set of positioning methods for a set of area IDs associated with one or more areas, where each of the set of positioning methods corresponds to one or more area IDs in the set of area IDs, where the positioning method configuration includes information associated with a performance of the set of positioning methods. The location component 198 may also be configured to transmit, for a user equipment (UE), a request to perform the set of positioning methods for at least one area ID in the set of area IDs associated with the one or more areas, where the request includes the positioning method configuration for the set of area IDs associated with the one or more areas. The location component 198 may also be configured to receive a report of at least one positioning method of the set of positioning methods based on the UE being within one area of the one or more areas. The location component 198 may also be configured to receive a second report of at least one second positioning method of the set of positioning methods based on the UE being within a second area of the one or more areas, where the at least one positioning method is different from the at least one second positioning method and a first area ID for the one area is different from a second area ID for the second area. The location component 198 may also be configured to receive, from the UE, an indication of a UE capability for an association of the set of area IDs to the set of positioning methods, where the positioning method configuration is configured based on the indication of the UE capability. The location component 198 may also be configured to receive an indication of a list of suitable or favored positioning methods, where the positioning method configuration is configured based on the list of suitable or favored positioning methods.

The location component 198 may be within one or more processors of one or more of the CU 1910, DU 1930, and the RU 1940. The location component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1902 may include a variety of components configured for various functions. In one configuration, the network entity 1902 may include means for configuring a positioning method configuration including a set of positioning methods for a set of area IDs associated with one or more areas, where each of the set of positioning methods corresponds to one or more area IDs in the set of area IDs, where the positioning method configuration includes information associated with a performance of the set of positioning methods. The network entity 1902 may also include means for transmitting, for a user equipment (UE), a request to perform the set of positioning methods for at least one area ID in the set of area IDs associated with the one or more areas, where the request includes the positioning method configuration for the set of area IDs associated with the one or more areas. The network entity 1902 may also include means for receiving a report of at least one positioning method of the set of positioning methods based on the UE being within one area of the one or more areas. The network entity 1902 may also include means for receiving a second report of at least one second positioning method of the set of positioning methods based on the UE being within a second area of the one or more areas, where the at least one positioning method is different from the at least one second positioning method and a first area ID for the one area is different from a second area ID for the second area. The network entity 1902 may also include means for receiving, from the UE, an indication of a UE capability for an association of the set of area IDs to the set of positioning methods, where the positioning method configuration is configured based on the indication of the UE capability. The network entity 1902 may also include means for receiving an indication of a list of suitable or favored positioning methods, where the positioning method configuration is configured based on the list of suitable or favored positioning methods. The means may be the location component 198 of the network entity 1902 configured to perform the functions recited by the means. As described supra, the network entity 1902 may include the TX processor 316, the RX processor 370, and the controller/processor 375. As such, in one configuration, the means may be the TX processor 316, the RX processor 370, and/or the controller/processor 375 configured to perform the functions recited by the means.

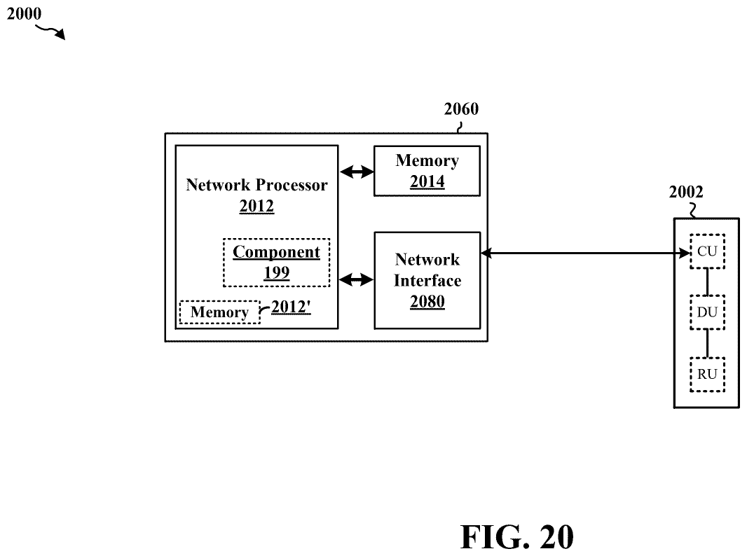

FIG. 20 is a diagram 2000 illustrating an example of a hardware implementation for a network entity 2060. In one example, the network entity 2060 may be within the core network 120. The network entity 2060 may include a network processor 2012. The network processor 2012 may include on-chip memory 2012′. In some aspects, the network entity 2060 may further include additional memory modules 2014. The network entity 2060 communicates via the network interface 2080 directly (e.g., backhaul link) or indirectly (e.g., through a RIC) with the CU 2002. The on-chip memory 2012′ and the additional memory modules 2014 may each be considered a computer-readable medium/memory. Each computer-readable medium/memory may be non-transitory. The processor 2012 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the location component 199 may be configured to configure a positioning method configuration including a set of positioning methods for a set of area IDs associated with one or more areas, where each of the set of positioning methods corresponds to one or more area IDs in the set of area IDs, where the positioning method configuration includes information associated with a performance of the set of positioning methods. The location component 199 may also be configured to transmit, for a user equipment (UE), a request to perform the set of positioning methods for at least one area ID in the set of area IDs associated with the one or more areas, where the request includes the positioning method configuration for the set of area IDs associated with the one or more areas. The location component 199 may also be configured to receive a report of at least one positioning method of the set of positioning methods based on the UE being within one area of the one or more areas. The location component 199 may also be configured to receive a second report of at least one second positioning method of the set of positioning methods based on the UE being within a second area of the one or more areas, where the at least one positioning method is different from the at least one second positioning method and a first area ID for the one area is different from a second area ID for the second area. The location component 199 may also be configured to receive, from the UE, an indication of a UE capability for an association of the set of area IDs to the set of positioning methods, where the positioning method configuration is configured based on the indication of the UE capability. The location component 199 may also be configured to receive an indication of a list of suitable or favored positioning methods, where the positioning method configuration is configured based on the list of suitable or favored positioning methods.

The location component 199 may be within the processor 2012. The location component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2060 may include a variety of components configured for various functions. In one configuration, the network entity 2060 may include means for configuring a positioning method configuration including a set of positioning methods for a set of area IDs associated with one or more areas, where each of the set of positioning methods corresponds to one or more area IDs in the set of area IDs, where the positioning method configuration includes information associated with a performance of the set of positioning methods. The network entity 2060 may also include means for transmitting, for a user equipment (UE), a request to perform the set of positioning methods for at least one area ID in the set of area IDs associated with the one or more areas, where the request includes the positioning method configuration for the set of area IDs associated with the one or more areas. The network entity 2060 may also include means for receiving a report of at least one positioning method of the set of positioning methods based on the UE being within one area of the one or more areas. The network entity 2060 may also include means for receiving a second report of at least one second positioning method of the set of positioning methods based on the UE being within a second area of the one or more areas, where the at least one positioning method is different from the at least one second positioning method and a first area ID for the one area is different from a second area ID for the second area. The network entity 2060 may also include means for receiving, from the UE, an indication of a UE capability for an association of the set of area IDs to the set of positioning methods, where the positioning method configuration is configured based on the indication of the UE capability. The network entity 2060 may also include means for receiving an indication of a list of suitable or favored positioning methods, where the positioning method configuration is configured based on the list of suitable or favored positioning methods. The means may be the location component 199 of the network entity 2060 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a user equipment (UE), including a memory and at least one processor coupled to the memory and, based at least in part on information stored in the memory, the at least one processor is configured to: obtain a request to perform a set of positioning methods for at least one area identifier (ID) in a set of area IDs associated with one or more areas, where the request includes a positioning method configuration for the set of area IDs associated with the one or more areas, where each of the set of positioning methods corresponds to one or more area IDs in the set of area IDs, where the positioning method configuration includes information associated with a performance of the set of positioning methods; perform at least one positioning method of the set of positioning methods based on the UE being within one area of the one or more areas associated with the set of area IDs; and transmit, for a network entity after the performance of the at least one positioning method, a report of the at least one positioning method based on the UE being within the one area of the one or more areas.

Aspect 2 is the apparatus of aspect 1, where each of the set of area IDs is associated with one or more positioning methods in the set of positioning methods, such that each of the set of area IDs is associated with a corresponding positioning method area ID in a set of positioning method area IDs, where each of the set of positioning method area IDs corresponds to a list of serving cell IDs or transmission-reception points (TRPs) associated with the one or more positioning methods.

Aspect 3 is the apparatus of any of aspects 1 to 2, where the set of positioning methods is associated with at least one of a set of artificial intelligence (AI)/machine learning (ML) models or a set of non-AI/ML models.

Aspect 4 is the apparatus of aspect 3, where each of the set of AI/ML models includes a direct AI/ML model including a positioning estimate output or an AI/ML-assisted model including a positioning measurement output, where the positioning measurement output includes at least one of: a reference signal time difference (RSTD), a reception-transmission (RxTx) time difference, a line-of-sight (LoS) indication, a reference signal received power (RSRP), path RSRP, or a reference signal received quality (RSRQ), and where each of the set of non-AI/ML models includes at least one of: a time difference of arrival (TDOA), a round-trip time (RTT), an angle of departure (AoD), a global navigation satellite system (GNSS), or Bluetooth.

Aspect 5 is the apparatus of any of aspects 1 to 4, where the at least one processor is further configured to: perform at least one second positioning method of the set of positioning methods based on the UE being within a second area of the one or more areas associated with the set of area IDs, where the at least one positioning method is different from the at least one second positioning method and a first area ID for the one area is different from a second area ID for the second area; and transmit a second report of the at least one second positioning method based on the UE being within the second area of the one or more areas.

Aspect 6 is the apparatus of any of aspects 1 to 5, where each of the set of area IDs is associated with a corresponding location information request, where the corresponding location information request for each of the set of area IDs enables multiple positioning methods of the set of positioning methods to be associated with the area ID.

Aspect 7 is the apparatus of any of aspects 1 to 6, where the at least one processor is further configured to: transmit, for the network entity, an indication of a UE capability for an association of the set of area IDs to the set of positioning methods, where the positioning method configuration is based on the indication of the UE capability.

Aspect 8 is the apparatus of aspect 7, where the indication of the UE capability includes an amount of artificial intelligence (AI)/machine learning (ML) models that the UE is capable of performing at a given time.

Aspect 9 is the apparatus of any of aspects 1 to 8, where the at least one processor is further configured to: transmit an indication of a list of suitable or favored positioning methods, where the positioning method configuration is based on the list of suitable or favored positioning methods.

Aspect 10 is the apparatus of any of aspects 1 to 9, where to transmit the report of the at least one positioning method, the at least one processor is configured to: transmit the report of the at least one positioning method at an end of a positioning session, or where to transmit the report of the at least one positioning method, the at least one processor is configured to: transmit the report of the at least one positioning method upon a change in one of the set of area IDs.

Aspect 11 is the apparatus of any of aspects 1 to 10, where the one area of the one or more areas corresponds to an area in which the UE is camped on a transmission-reception point (TRP) in a set of TRPs within the one or more areas.

Aspect 12 is the apparatus of any of aspects 1 to 11, where each of the set of positioning methods includes at least one positioning measurement including one or more of: a reference signal time difference (RSTD), a reception-transmission (RxTx) time difference, a line-of-sight (LoS) indication, a reference signal received power (RSRP), a path RSRP, or a reference signal received quality (RSRQ).

Aspect 13 is the apparatus of any of aspects 1 to 12, where the request to perform the set of positioning methods includes a list of suitable or favored positioning methods for the set of area IDs.

Aspect 14 is the apparatus of any of aspects 1 to 13, further including at least one of a transceiver or an antenna coupled to the at least one processor, where to transmit the report of the at least one positioning method, the at least one processor is configured to: transmit the report of the at least one positioning method via at least one of the transceiver or the antenna, and where the request to perform the set of positioning methods corresponds to a positioning session for the UE.

Aspect 15 is an apparatus for wireless communication at a network entity, including a memory and at least one processor coupled to the memory and, based at least in part on information stored in the memory, the at least one processor is configured to: configure a positioning method configuration including a set of positioning methods for a set of area IDs associated with one or more areas, where each of the set of positioning methods corresponds to one or more area IDs in the set of area IDs, where the positioning method configuration includes information associated with a performance of the set of positioning methods; transmit, for a user equipment (UE), a request to perform the set of positioning methods for at least one area ID in the set of area IDs associated with the one or more areas, where the request includes the positioning method configuration for the set of area IDs associated with the one or more areas; and receive a report of at least one positioning method of the set of positioning methods based on the UE being within one area of the one or more areas.

Aspect 16 is the apparatus of aspect 15, where each of the set of area IDs is associated with one or more positioning methods in the set of positioning methods, such that each of the set of area IDs is associated with a corresponding positioning method area ID in a set of positioning method area IDs, where each of the set of positioning method area IDs corresponds to a list of serving cell IDs or transmission-reception points (TRPs) associated with the one or more positioning methods.

Aspect 17 is the apparatus of any of aspects 15 to 16, where the set of positioning methods is associated with at least one of a set of artificial intelligence (AI)/machine learning (ML) models or a set of non-AI/ML models.

Aspect 18 is the apparatus of aspect 17, where each of the set of AI/ML models includes a direct AI/ML model including a positioning estimate output or an AI/ML-assisted model including a positioning measurement output, where the positioning measurement output includes at least one of: a reference signal time difference (RSTD), a reception-transmission (RxTx) time difference, a line-of-sight (LoS) indication, a reference signal received power (RSRP), path RSRP, or a reference signal received quality (RSRQ), and where each of the set of non-AI/ML models includes at least one of: a time difference of arrival (TDOA), a round-trip time (RTT), an angle of departure (AoD), a global navigation satellite system (GNSS), or Bluetooth.

Aspect 19 is the apparatus of any of aspects 15 to 18, where the at least one processor is further configured to: receive a second report of at least one second positioning method of the set of positioning methods based on the UE being within a second area of the one or more areas, where the at least one positioning method is different from the at least one second positioning method and a first area ID for the one area is different from a second area ID for the second area.

Aspect 20 is the apparatus of any of aspects 15 to 19, where each of the set of area IDs is associated with a corresponding location information request, where the corresponding location information request for each of the set of area IDs enables multiple positioning methods of the set of positioning methods to be associated with the area ID.

Aspect 21 is the apparatus of any of aspects 15 to 20, where the at least one processor is further configured to: receive, from the UE, an indication of a UE capability for an association of the set of area IDs to the set of positioning methods, where the positioning method configuration is configured based on the indication of the UE capability.

Aspect 22 is the apparatus of aspect 21, where the indication of the UE capability includes an amount of artificial intelligence (AI)/machine learning (ML) models that the UE is capable of performing at a given time.

Aspect 23 is the apparatus of any of aspects 15 to 22, where the at least one processor is further configured to: receive an indication of a list of suitable or favored positioning methods, where the positioning method configuration is configured based on the list of suitable or favored positioning methods.

Aspect 24 is the apparatus of any of aspects 15 to 23, where to receive the report of the at least one positioning method, the at least one processor is configured to: receive the report of the at least one positioning method at an end of a positioning session, or where to receive the report of the at least one positioning method, the at least one processor is configured to: receive the report of the at least one positioning method upon a change in one of the set of area IDs.

Aspect 25 is the apparatus of any of aspects 15 to 24, where the one area of the one or more areas corresponds to an area in which the UE is camped on a transmission-reception point (TRP) in a set of TRPs within the one or more areas.

Aspect 26 is the apparatus of any of aspects 15 to 25, where each of the set of positioning methods includes at least one positioning measurement including one or more of: a reference signal time difference (RSTD), a reception-transmission (RxTx) time difference, a line-of-sight (LoS) indication, a reference signal received power (RSRP), a path RSRP, or a reference signal received quality (RSRQ).

Aspect 27 is the apparatus of any of aspects 15 to 26, where the request to perform the set of positioning methods includes a list of suitable or favored positioning methods for the set of area IDs.

Aspect 28 is the apparatus of any of aspects 15 to 27, further including at least one of a transceiver or an antenna coupled to the at least one processor, where to receive the report of the at least one positioning method, the at least one processor is configured to: receive the report of the at least one positioning method via at least one of the transceiver or the antenna, and where the request to perform the set of positioning methods corresponds to a positioning session for the UE.

Aspect 29 is the apparatus of any of aspects 1 to 28, where the apparatus is a wireless communication device, further including at least one of an antenna or a transceiver coupled to the at least one processor.

Aspect 30 is a method of wireless communication for implementing any of aspects 1 to 28.

Aspect 31 is an apparatus for wireless communication including means for implementing any of aspects 1 to 28.

Aspect 32 is a computer-readable medium (e.g., a non-transitory computer-readable medium) storing computer executable code, the code when executed by at least one processor causes the at least one processor to implement any of aspects 1 to 28.

1. An apparatus for wireless communication at a user equipment (UE), comprising: a memory; and
at least one processor coupled to the memory and, based at least in part on first information stored in the memory, the at least one processor is configured to:
obtain a request to perform a set of positioning methods for at least one area identifier (ID) in a set of area IDs associated with one or more areas, wherein the request includes a positioning method configuration for the set of area IDs associated with the one or more areas, wherein each of the set of positioning methods corresponds to one or more area IDs in the set of area IDs, wherein the positioning method configuration includes information associated with a performance of the set of positioning methods;
perform at least one positioning method of the set of positioning methods based on the UE being within one area of the one or more areas associated with the set of area IDs; and
transmit, for a network entity after the performance of the at least one positioning method, a report of the at least one positioning method based on the UE being within the one area of the one or more areas.

2. The apparatus of claim 1, wherein each of the set of area IDs is associated with one or more positioning methods in the set of positioning methods, such that each of the set of area IDs is associated with a corresponding positioning method area ID in a set of positioning method area IDs, wherein each of the set of positioning method area IDs corresponds to a list of serving cell IDs or transmission-reception points (TRPs) associated with the one or more positioning methods.

3. The apparatus of claim 1, wherein the set of positioning methods is associated with at least one of a set of artificial intelligence (AI)/machine learning (ML) models or a set of non-AI/ML models.

4. The apparatus of claim 3, wherein each of the set of AI/ML models includes a direct AI/ML model including a positioning estimate output or an AI/ML-assisted model including a positioning measurement output, wherein the positioning measurement output includes at least one of: a reference signal time difference (RSTD), a reception transmission (RxTx) time difference, a line-of-sight (LoS) indication, a reference signal received power (RSRP), path RSRP, or a reference signal received quality (RSRQ), and wherein each of the set of non-AI/ML models includes at least one of: a time difference of arrival (TDOA), a round-trip time (RTT), an angle of departure (AoD), a global navigation satellite system (GNSS), or Bluetooth.

5. The apparatus of claim 1, wherein the at least one processor is further configured to:
perform at least one second positioning method of the set of positioning methods based on the UE being within a second area of the one or more areas associated with the set of area IDs, wherein the at least one positioning method is different from the at least one second positioning method and a first area ID for the one area is different from a second area ID for the second area; and
transmit a second report of the at least one second positioning method based on the UE being within the second area of the one or more areas.

6. The apparatus of claim 1, wherein each of the set of area IDs is associated with a corresponding location information request, wherein the corresponding location information request for each of the set of area IDs enables multiple positioning methods of the set of positioning methods to be associated with the area ID.

7. The apparatus of claim 1, wherein the at least one processor is further configured to:
transmit, for the network entity, an indication of a UE capability for an association of the set of area IDs to the set of positioning methods, wherein the positioning method configuration is based on the indication of the UE capability.

8. The apparatus of claim 7, wherein the indication of the UE capability includes an amount of artificial intelligence (AI)/machine learning (ML) models that the UE is capable of performing at a given time.

9. The apparatus of claim 1, wherein the at least one processor is further configured to: transmit an indication of a list of suitable or favored positioning methods, wherein the positioning method configuration is based on the list of suitable or favored positioning methods.

10. The apparatus of claim 1, wherein to transmit the report of the at least one positioning method, the at least one processor is configured to: transmit the report of the at least one positioning method at an end of a positioning session, or wherein to transmit the report of the at least one positioning method, the at least one processor is configured to: transmit the report of the at least one positioning method upon a change in one of the set of area IDs.

11. The apparatus of claim 1, wherein the one area of the one or more areas corresponds to an area in which the UE is camped on a transmission-reception point (TRP) in a set of TRPs within the one or more areas.

12. The apparatus of claim 1, wherein each of the set of positioning methods includes at least one positioning measurement including one or more of: a reference signal time difference (RSTD), a reception-transmission (RxTx) time difference, a line-of-sight (LoS) indication, a reference signal received power (RSRP), a path RSRP, or a reference signal received quality (RSRQ).

13. The apparatus of claim 1, wherein the request to perform the set of positioning methods includes a list of suitable or favored positioning methods for the set of area IDs.

14. The apparatus of claim 1, further comprising at least one of a transceiver or an antenna coupled to the at least one processor, wherein to transmit the report of the at least one positioning method, the at least one processor is configured to: transmit the report of the at least one positioning method via at least one of the transceiver or the antenna, and wherein the request to perform the set of positioning methods corresponds to a positioning session for the UE.

15. An apparatus for wireless communication at a network entity, comprising:
a memory; and
at least one processor coupled to the memory and, based at least in part on first information stored in the memory, the at least one processor is configured to:
configure a positioning method configuration including a set of positioning methods for a set of area IDs associated with one or more areas, wherein each of the set of positioning methods corresponds to one or more area IDs in the set of area IDs, wherein the positioning method configuration includes information associated with a performance of the set of positioning methods;
transmit, for a user equipment (UE), a request to perform the set of positioning methods for at least one area ID in the set of area IDs associated with the one or more areas, wherein the request includes the positioning method configuration for the set of area IDs associated with the one or more areas; and receive a report of at least one positioning method of the set of positioning methods based on the UE being within one area of the one or more areas.

16. The apparatus of claim 15, wherein each of the set of area IDs is associated with one or more positioning methods in the set of positioning methods, such that each of the set of area IDs is associated with a corresponding positioning method area ID in a set of positioning method area IDs, wherein each of the set of positioning method area IDs corresponds to a list of serving cell IDs or transmission-reception points (TRPs) associated with the one or more positioning methods.

17.-18. (canceled)

19. The apparatus of claim 15, wherein the at least one processor is further configured to: receive a second report of at least one second positioning method of the set of positioning methods based on the UE being within a second area of the one or more areas, wherein the at least one positioning method is different from the at least one second positioning method and a first area ID for the one area is different from a second area ID for the second area.

20. (canceled)

21. The apparatus of claim 15, wherein the at least one processor is further configured to:
receive, from the UE, an indication of a UE capability for an association of the set of area IDs to the set of positioning methods, wherein the positioning method configuration is configured based on the indication of the UE capability.

22.-23. (canceled)

24. The apparatus of claim 15, wherein to receive the report of the at least one positioning method, the at least one processor is configured to: receive the report of the at least one positioning method at an end of a positioning session, or wherein to receive the report of the at least one positioning method, the at least one processor is configured to: receive the report of the at least one positioning method upon a change in one of the set of area IDs.

25.-28. (canceled)

29. A method of wireless communication at a user equipment (UE), comprising:
obtaining a request to perform a set of positioning methods for at least one area identifier (ID) in a set of area IDs associated with one or more areas, wherein the request includes a positioning method configuration for the set of area IDs associated with the one or more areas, wherein each of the set of positioning methods corresponds to one or more area IDs in the set of area IDs, wherein the positioning method configuration includes information associated with a performance of the set of positioning methods;
performing at least one positioning method of the set of positioning methods based on the UE being within one area of the one or more areas associated with the set of area IDs; and
transmitting, for a network entity after the performance of the at least one positioning method, a report of the at least one positioning method based on the UE being within the one area of the one or more areas.

30. (canceled)
